(19) United States
(12) Patent Application Publication
(10) Pub. No.: US 2022/0198528 A1
(43) Pub. Date: Jun. 23, 2022

(54) Donation Incented Real Time Payment

(71) Applicant: edatanetworks, Inc., Edmonton (CA)

(72) Inventors: Terrance Patrick TIETZEN, Edmonton (CA); Matthew Arnold Macpherson BATES, Beaumont (CA)

(73) Assignee: edatanetworks, Inc., Edmonton (CA)

(21) Appl. No.: 17/687,621

(22) Filed: Mar. 5, 2022

(51) Int. Cl. G06Q 30/02; G06Q 20/40; G06Q 20/10

(52) U.S. Cl. CPC G06Q 30/0279; G06Q 20/102; G06Q 20/4015

(57) ABSTRACT

A donor incentivizes a payer to make a real time payment to a payee, as facilitated by operation of one RTPS Technology, by terms set by the donor to make an auditable donation to an affinity entity designated by the payer. To incent such real time payments within a predetermined geographic location, the donor's terms may limit its donation by a derivation of navigation time between the payer and payee, and/or by date and time of the real time payment from the payer to the payee. The payer can direct the donation by the donor to one of more affinity entities within the payer's own geographic community, and/or within a community where the real time payment was physically conducted. An payer can also make a donation to the affinity entity at the time of real time payment by the payer where the donation by the payer is paid by a payer financial institution that issued a payer account of the payer. Other participants in a real time payment system facilitated by operation of the one of the RTPS Technologies may also make donations to the affinity entity in order to incent real time payments, including the payer financial institution, a payee financial institution, a sponsor who funds a stored value account from which funds are withdrawn to make the real time payment from the payer to the payee.

### CROSS REFERENCE TO RELATED APPLICATIONS

This utility patent application incorporates by reference each of the following in their respective entireties: (i) U.S. Pat. No. 11,042,882, titled “Real-time payment system, method, apparatus, and computer program”, U.S. patent application Ser. No. 15/200,340, filed on Jul. 1, 2016; (ii) US Patent Application Publication No. 2021-0073750 A1, titled “Real-Time Payment System, Method, Apparatus, and Computer Program”, U.S. patent application Ser. No. 17/099,609, filed on Nov. 16, 2020; (iii) U.S. Pat. No. 9,626,664, titled “System and method for transferring funds”, U.S. patent application Ser. No. 13/735,189, filed on Jan. 7, 2013; (iv) U.S. Pat. No. 9,626,664, titled “System and method for transferring funds”, U.S. patent application Ser. No. 13/735,189, filed on Jan. 7, 2013; (v) U.S. Pat. No. 10,078,821, titled “System and method for securely registering a recipient to a computer-implemented funds transfer payment network”, U.S. patent application Ser. No. 13/735,152, filed on Jan. 7, 2013; and (vi) U.S. Pat. No. 10,438,175, titled “Secure real-time payment transactions”, U.S. patent application Ser. No. 14/805,214, filed on Jul. 21, 2005. The foregoing references are referred to herein, individually and collectively, as “Real Time Payment System (RTPS) Technologies”.

### FIELD

Embodiments of the present invention relate generally to the field of transferring funds. In particular, they relate to systems and methods for generating and maintaining a real time payment system. Implementations further generally relate to an incentive by a donor to incent a payer to make a real time payment to a payee, and more particularly for the donor to provide to the incentive of making a donation to an affinity entity in exchange for the payer making a real time payment to a payee from an account issued to the payer by a payer financial institution to account issued to the payee by a payee financial institution.

### BACKGROUND

Payments made between individuals are often made with cash or checks. Payments for items and services purchased from businesses are often also made with cash or checks, and are also often made using credit cards or debit cards. While these payment mechanisms have worked well, enhanced systems and methods of facilitating such payments would be desirable.

Banking customers interact frequently with banks or financial institutions for payment-related matters, such as buying a financial product, checking on a payment, or paying a bill. Payment revenue from such interactions is increasingly targeted by non-banks and competition for payment revenue is intensifying, particularly in the area of mobile payments and digital payments. Financial transfers today take place more quickly than before via RTPS Technologies, including but not limited to those that are disclosed in (i) U.S. Pat. No. 11,042,882, (ii) US Patent Application Publication No. 2021-0073750 A1, (iii) U.S. Pat. No. 9,626,664, (iv) U.S. Pat. No. 10,078,821, and (v) U.S. Pat. No. 10,438,175. Each such real time payment system focuses on fast payments capabilities.

Advantageously, RTPS Technologies are respective technologies by which payments are initiated and settled nearly instantaneously. A real-time payments rail is the digital infrastructure that facilitates real-time payments. Ideally, real-time payment networks provide 24×7×365 access, which means they are always online to process transfers. RTPS Technologies are technologies in which a payment processing network is used to send money electronically between financial institutions. RTPS Technologies transfer funds between two financial institution accounts instantaneously and are available year round. RTPS Technologies process transactions on financial institution holidays and weekends, and after business hours. Unlike ACH, which supports “push” and “pull” transactions, RTPS Technologies only support push transactions. Stated otherwise, a payee cannot debit or pull from a payer's financial institution account via RTPS Technologies. There is an option to send a “request for payment,” but it is up to the payer to initiate a push payment to the payee.

Benefits of RTPS Technologies include: (i) The ability to move rich data (via ISO 20022 adoption) that can provide actionable insights into corporate client needs; (ii) Confirmation of payment; (iii) Control over payments timing; (iv) Liquidity management; (v) Instant bill payment; and (vi) Remittance data availability.

Exemplary of RTPS Technologies is The Clearing House's RTP network. FedNow, the Federal Reserve's anticipated real-time solution, will also fall under the definition of a real-time network. The term real-time payments should not be used interchangeably with the term faster payments. While they are similar, there are some key differences. Faster payments solutions, such as Nacha's Same Day ACH, post and settle payments faster than traditional payment rails, but faster does not mean instantaneously. Other payment solutions, like Mastercard's and Visa's push payment solutions will message transactions within seconds or minutes. However, because they do not also settle transactions quickly, push payments are considered a faster but not real-time payments. While all real-time payments can be considered a form of faster payments, not all faster payments are conducted in real time.

In recent years, Peer-To-Peer (P2P) payments have increases, with applications (apps) such as Zelle, Venmo, and PayPal replacing cash, checks, and IOUs. Now, individuals who want to split the cost of dinner, a ride share, or rent and utilities can send payments to one another in an instant. Consumers are increasingly adopting P2P payment apps. Due to their integration with The Clearing House's RTP network, multiple P2P payment apps can transfer money instantaneously from the app to a bank account. For instance, instant transfers routed through the TCH RTP network can be done on PayPal's Venmo.

A Peer To Peer (P2P) payment is made by a payer account holder to a payee account holder, where each account holder has been issued an account respectively by a payor financial institution and a payee financial institution. The P2P payment is initiated by the payor account holder sending to the payor financial institution a request to make the P2P payment to the payee financial institution for the benefit of the payee account holder. The request includes the date and the time, a currency amount of the P2P payment, and identifiers for each of the payor account holder, the payee account holder, the payor financial institution, and the payee financial institution.

An affirmative response by the payee financial institution is transmitted by the payor financial institution back to the payor financial institution. To initiate the clearing and settlement of the P2P payment from the account of the payor account holder to the account of the payee account holder as facilitated by the payor financial institution and the payee financial institution.

In certain circumstances, it may be advantageous and therefore desired to limit the time required for a payment to be made by a payer to a payee, such as when there is a need for liquidity and instant access to cash, and as where there is a desire to reduce a float of money being lent for a period of time to a payer to make a payment to a payee. In financial terms, the float in this instance is money within a banking system that is briefly counted twice due to time gaps in registering a deposit or withdrawal. These time gaps are usually due to the delay in processing paper checks. A financial institution credits a payer's account as soon as a check is deposited. However, it takes some time to receive a check from the payer's financial institution and record it. Until the check clears the payer's account it is drawn on, the amount it is written for “exists” in two different places, appearing in the accounts of both the payee's and payer's financial institutions. As such, the float for which the time duration thereof is desired to be reduced is essentially double-counted money, namely a paid sum which, due to delays in processing, appears simultaneously in the accounts of the payer and the payee. The Federal Reserve (The Fed) defines two types of float. Holdover float results from delays at the processing institution, typically due to the weekend and seasonal backlogs. Transportation float occurs due to inclement weather and air traffic delays and is, therefore, highest in the winter months. The Fed—which processes one-third of all checks in the United States—observes that although the amount of float fluctuates randomly, there are definite weekly and seasonal trends. For example, float usually increases on a Tuesday due to a backlog of checks over the weekend and during the months of December and January because of higher check volume during the holiday season.

A payer may find it desirable to use float to their advantage. For example, a payer might owe a payee a payment for $500 due April 1. On March 23, the payer writes and mails a check-in that amount, even though payer doesn't have $500 in a checking account issued to the payer by a payer financial institution. However, the payer knows that the funds are soon to be paid to the payer which funds will thereafter be deposited in the payer's checking account by March 25—and the payer counts on the fact that the payee to whom the $500 payment is due probably won't receive and present the payer's check for payment until April 1. The payer thus has $500 worth of float—the time between the writing of the check by the payer and the time that the payer's check clears—for those days. If the payer were sophisticated, the payer could essentially do the same thing by going online on March 23 and scheduling an electronic payment on the payee website for April 1, again counting for the payer's financial institution to have posted the payer's expected funds by March 25.

Technological advances have spurred the adoption of measures that substantially speed up payment and hence reduce float. These measures include the widespread use of electronic payments and electronic funds transfers, the direct deposit of employee paychecks by employers, and the scanning and electronic presentation of checks—instead of their physical transfer. However, the furthermost advance to reduce float are accomplished by way of the RTPS Technologies incorporated herein.

While it may be in the interest of payers to use float to their advantage, gaining time or earning interest before payment clears the payer's financial interest, the float may not be in the interest of the payee who, perhaps by placing some emphasis on the time value of money, thus wishes to reduce the float and thereby receive liquidity and instant access to cash by way of the use a real time payment system to receive a real time payment from the payer. As such, the payee, and perhaps other participants in any of the RTPS Technologies, may wish to provide incentives to a payer to make a real time payment to a payee.

In the state of the art of real time payment systems, there is a need to develop and implement real time payment systems to better meet consumers' and businesses' expectations in an increasingly digital economy, where a payer in a real time payment within a real time payment system is incented to make real time payment to a payee by way of an incentive provided by a donor who will be obligated to make a donation to an affinity entity (i.e., a charity) in exchange for the payer make a real time payment to the payee.

### SUMMARY

One or more implementations relate to methods where, for each real time payment (RTP) from a payer to a payee, information is received that is derived from an authorization response for the RTP, where the information includes the date and the time, a currency amount, and identifies for the payer and payee. For each RTP for which the date and time of the corresponding authorization response are within a predetermined time period, and for each identifier for the payee, there is a deriving of the sum of the currency amounts by using the identifier for the payee to access a database to retrieve (i) the logical address for the payee, or its agent, corresponding to the identifier for the payee and (ii) a business rule for a donor to make a donation corresponding to an identifier for an affinity entity or charity having a logical address, wherein in the currency amount of each donation is a function, at least in part, of the currency amount of each RTP. A RTP is made to the logical address for the payee, or its agent, where the RPT includes a process to facilitate the donation to the affinity entity or charity for the predetermined time-period. Within a predetermined audit time-period for and after the predetermined time-period, a plurality of donation receipts are received, each including (i) the respective identifiers for the affinity entity or charity and the payee and (ii) a currency amount. For each identifier for the payee, the sum of the currency amounts of the donation receipts for each identifier for the affinity entity or charity are derived.

After the predetermined audit time-period for the predetermined time, for each identifier for the payee, and for each identifier corresponding to each affinity entity or charity to whom a donation was to be made as per the retrieved business rule, a determination is made of a difference between: (i) the donation for the predetermined time period that was transmitted to the logical address of the payee, and (ii) the sum of the currency amounts of the donation receipts received for the affinity entity or charity for the predetermined time period. Then, the determined difference is transmitted to the logical address for the payee, or its agent.

In various implementations, an account issued by a financial institution to an account holder can be a revolving credit account, a debit account, a charge account, an Automatic Teller Machine (AMT) account, a prepaid account, a gift account, etc.

In other implementations, the affinity entities to which the payee donates can be limited to those within the payee's community, within the payee's community, within both communities, or within neither community. In still further implementations, the payees can designate those affinity entities to which the payee is to make a donation, regardless of the location or charitable object or mission of the affinity entity. In yet other implementations, each RTP has a donor specified by one or both the payer and payee who can make the donation on the payee's behalf incident to clearing and settling the RTP with the financial institution that issued the account to the payee, and where, optionally, the donor's donation can be in the form of an adjustment to exchange rate assessed to the payee against the RTP currency amount for conducting the RPT on the payer's account. Participants in a real time payment system, include: (i) the payer; (ii) the payee; (iii) the payer financial institution; (iv) the payee financial institution; (v) the donor who incents the payer to make a real time payment to the payee by making a donation to an affinity entity selected by the payer; and (vi) an operator of a real time payments system making a donation on behalf of a third party (e.g.; An operator of a real time payments system, such as Fiserv, Inc., who provides financial technology and financial services to a variety of clientele including banks, thrifts, credit unions, securities broker dealers, leasing and finance companies, and retailers, on behalf of a clearing house (e.g., A clearing house, such as “The Clearing House”, having a place of business on the 17th Floor, 1114 A venue of the Americas, New York, N.Y. 10036, which is a designated intermediary between a buyer and seller in a financial market, where the clearinghouse validates and finalizes transactions to ensure that both the buyer and the seller honor their contractual obligations. Every financial market has a designated clearinghouse or an internal clearing division to handle this function.)). Each of the foregoing entities, (i) through (vi), can similarly also make donations to one or more affinity entities that have been selected by any one or more of the foregoing entities, (i) through (v), as yet further incentives to the payer to make a real time payment to the payee.

In still further implementations, a donor funds and makes direct payment of all donations to one or more affinity entities or charities designated by the payer, where the donation by the donor is made according to the donor's designated business rule, wherein, in a variation thereof, the donor funds and makes direct payment of all donations to the one or more affinity entities or charities designated by the payer, where such donations are only made if the affinity entity or charity is located in, and/or provide services to, the donor's neighborhood, which may be defined geographically or by other definitions such as travel time between a donor's geographic location to the affinity entity's or charity's geographic location.

In yet further implementations, a donor funds and the donor's financial institution makes direct payment, incident to a process of closing and settlement of an associated real time payment from a payer to a payee, where all donations from the donor to all affinity entities or charities for those real time payments made by payers to payees are conducted on respective accounts issued to the payer and payee respectively by the payer financial institution and the payee financial institution.

In still further implementations, a payee funds each donation and the payer's financial institution makes direct payment, incident to a process of closing and settlement of a real time payment, where of all of the payee's donations to all charities for those real time payments conducted by the payer and payee on respective accounts issued to the payer and payee by respective financial institutions, wherein, in a variation thereof, the donations are made to those affinity entities or charities having a physical location within the payee's neighborhood, which may or may not be a geographically defined community.

In still further implementations, both the payee and the payee's financial institution make a donation as an incentive for a payer to make a real time payment to the payee, where each such donation is made to an affinity entity selected by the payer, incident to a process of closing and settlement of the real time payment. In a variation of such implementations, the donations are made to those affinity entities designated by the payer, which affinity entities may have a physical location within a neighborhood where one or both of the payee and the payee's financial institution have a geographic location and/or brick and mortar store location. In a still further variation thereof, a downward adjustment is made to an exchange fee for the real time payment assessed to the payee by the payee's financial institution such that the payee is able to pay a lower exchange fee to compensate for the payee's charitable contribution, and, optionally, the payee's financial institution for the real time payment can also pay the same local charities a donation out of increased real time payment volume due to the incentive to make the donation when a real time payment is made from a payer to a payee.

In yet further implementations, the payee funds and the payee's financial institution makes a direct payment, incident to a process of closing and settlement of a real time payment, of all donations to all payer designated charities for those real time payments made by the payer to the payee on an account issued to the payer by the payer's financial institution, wherein the payee matches at least a portion of the payee's contribution to the affinity entity or charity by the payee's financial institution making direct payment to that affinity entity or charity incident to a process of closing and settlement of the real time payment such as by way of an assessment made to the payer's account held by the payer financial institution, whereby the payer's charitable donation that is rendered as a statement debit on the payer's account statement with the payer financial institution.

Variations on the foregoing implementations include allowing the payer to specify one or more affinity entities (e.g., charities) that provide goods and/or services to the payer's local community to which donations are to made by payee to whom the payer makes a real time payment. In such implementations, each payee is given notice of its total periodic obligatory donations. Such notice, however, is given without providing the payee with any notice or knowledge as to the specific identity of those affinity entities that are to be its recipients, where each such recipient is selected by the payee without knowledge by the payer. Such implementations leave the direction of payer's donations fully within the discretion of the payer. In some implementations, the payer's discretion can be limited by the restriction that the payer can only select affinity entities from among those that serve the local community in common to both the payer and payee, while leaving the actual amount of the payee's donation fully within the discretion of the payee. Variations on such implementations include alternative definitions for the local community in common to both the payee and payer.

Still further variations on the foregoing implementations include deriving a donation to be made by the payee to the affinity entity for a predetermined time-period by using a payee donation business rule as well as a rule previously specified by the payer who makes a real time payment to the payee via one of the RTPS Technologies. By way of example, and not by way of limitation, the payee's donation business rule might choose the amount of the donation whereas the payer might choose an affinity entity that is not located in the same community or either the payer or the payee.

In yet further variations on the foregoing implementations, a payer makes a real time payment to a payee, where an incentive is offered by a donor to the payer to make the real time payment to the payee, where the incentive by the donor is an offer to make a donation to an affinity entity elected by the payee, where the donor is one or more of the following entities: (i) the payee; the payee financial institution; (ii) payer financial institution; (iii) a sponsor of a stored value account held by a stored value financial institution; (iv) a donor that is none of the foregoing; and (v) a donor that is a combination of any of the foregoing.

In any of the foregoing implementations, the donation by the donor which serves as an incentive to the payer to make a real time payment to the payer may be made subject to one or more conditions upon which the donation will be made. These conditions may include a provision that the real time payment from the payer to the payee is made during a predetermined time-period by use of one of the RTPS Technologies, and may include another provision that the affinity entity to whom the donation by the donor is to be made be associated with a geographic location (e.g., a residence, a brick and mortar store, a city limit, a county limit, etc.) to which travel by one or more predetermined navigation methods can be accomplished during the predetermined time-period, as determined by real time traffic information, with a certain amount of time that is less than a predetermined navigation time threshold.

It will be appreciated that the foregoing summary merely describes exemplary implementations to which claimed subject matter is not limited.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIGS. 1-2 are flowcharts illustrating respective exemplary processes that allow a payer to make a real time payment to a payee via RTPS Technologies, where at least one of the payer and the payee is incented to participate in the real time payment real time payment by an obligation of one or more donors to make a donation one or more affinity entities each of which may also be a charitable organization (e.g., a charity), where the donor is one or more of the following entities: (i) the payee; (ii) the payee financial institution; (iii) payer financial institution; (iv) a sponsor of a stored value account held by a stored value financial institution; (v) a donor that is none of the foregoing; (vi) an operator of a real time payments system who is a donor making a donation on behalf of a third party (e.g.; An operator of a real time payments system, such as Fiserv, Inc., who provides financial technology and financial services to a variety of clientele including banks, thrifts, credit unions, securities broker dealers, leasing and finance companies, and retailers, on behalf of a clearing house (e.g., A clearing house, such as “The Clearing House”, having a place of business on the 17th Floor, 1114 A venue of the Americas, New York, N.Y. 10036, which is a designated intermediary between a buyer and seller in a financial market, where the clearinghouse validates and finalizes transactions to ensure that both the buyer and the seller honor their contractual obligations. Every financial market has a designated clearinghouse or an internal clearing division to handle this function.)); (vii) and a donor that is some combination of any of the foregoing;

FIG. 3 illustrates an exemplary real time payments system (RTPS) in which the processes of FIGS. 1-2 can be performed, where a payer makes a real time payment to a payee via RTPS Technologies, wherein, for each real time payment from a payer to a payee respectively associated with a payer financial institution and a payee financial institution, where the real time payment from the payer to the payee is processed through the RTPS as disclosed in one or more of the RTPS Technologies incorporated herein, where there are authorizing and remunerating of an electronic real time payment by a payer account holder to a payee account holder, where the real time payment triggers an obligation by one or more donors to make one or more donations, where each such donation is made by a donor to one or more affinity entities each of which may be a charity, and where each such donation is incident to the real time payment, and where the donor is one or more of the following entities: (i) the payee; the payee financial institution; (ii) payer financial institution; (iii) a sponsor of a stored value account held by a stored value financial institution; (iv) a donor that is none of the foregoing; and (v) a donor that is a combination of any of the foregoing;

FIGS. 4a-4b illustrate respective shots characterizing exemplary user interfaces for use of an incentor, where the incentor wishes to incent a donor who will provide a payer with an incentive to make a real time payment to a payee, where the payer is incented by the donor who will make a donation to one or more affinity entities, where optionally one or more such affinity entities can be selected by the payer, where the donor designates those terms and conditions under which the donor will make the donation to the one or more affinity entities incident to a real time payment being made from the payer to the payee. Note that FIGS. 4a-4b indicates an implementation in which the payee is designated as being the “incentor” who designates rules and conditions for the donation that is to be made by the donor to the one or more affinity entities, which affinity entities can optionally be selected by the incentee by way of the user interface shown in FIGS. 5a-5b to be discussed below. Note also that the one or more affinity entities are designated by way of the user interface shown in FIGS. 4a-4b, where the incentor has input fields for an incentor identifier, and an incentor community identifier; and

FIGS. 5a-5b illustrate screen shots characterizing exemplary user interfaces for the specification by an incentee of directing donations to one or more affinity entities to whom a donation will be made by a donor, where the one or more donations are triggered by a real time payment from a payer to a payee. Note that FIGS. 5a-5b indicates an implementation in which the payee is designated as being the “incentee” who designates each of the one or more affinity entities by way of the user interface. The incentee in FIGS. 5a-5b has input fields for an incentee account number, and affinity identifiers with respective community identifiers.

Implementations will become more apparent from the detailed description set forth below when taken in conjunction with the FIGS.

### DETAILED DESCRIPTION

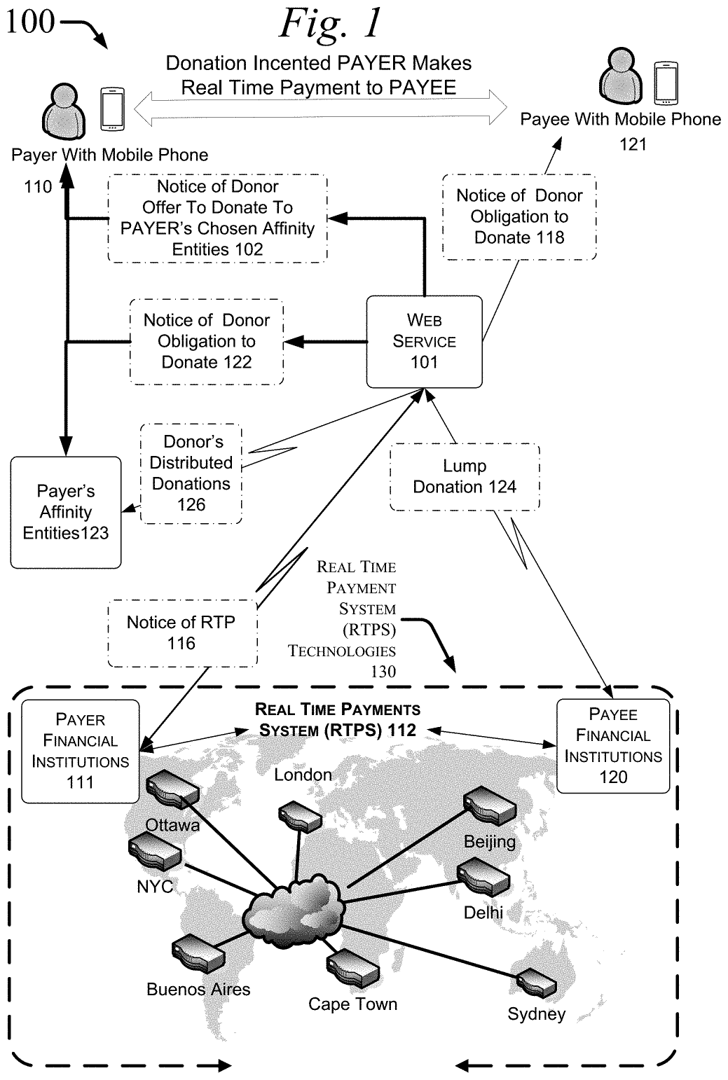

Referring now to FIG. 1, a system drawings 100 is depicted for a global real time payments system where a payer is incented to make a real time payment to a payee, where the incentive is an offer to the payer by way of a donation by a donor to an affinity entity (i.e., a charity) selected by the payer, or where the incentive is an offer to the payee by way of a donation by a donor to an affinity entity (i.e., a charity) selected by the payee, or where the incentive is an offer to both the payer and the payee by way of a donation by a donor to an affinity entity (i.e., a charity) selected by one or both of the payer and payee. Optionally, the donation can be made by one or more donors to one of more affinities entities selected by one or both of the payer and payee.

Implementations of the RTPS Technologies incorporated herein are applicable to the invention of the present application, as are each of the following:
Australia: NPP—New Payments Platform;
Brazil: Pix;
Peoples Republic China: IBPS—Internet banking payment system;
Denmark: MobilePay;
Europe: RT1 and TARGET Instant Payments Settlement (TIPS);
Hong Kong: Faster Payment System;
India: Immediate Payment Service (IMPS), Unified Payments Interface (UPI);
Japan: ZENGIN;
Norway: Vipps;
Philippines: InstaPay;
Russia: Sistema (bystrykh platezhey) and Fast Payments System;
Sweden: Swish;
United Kingdom: Faster Payments Service (FPS) which is operated by VocaLink; and
United States: Zelle, Venmo, and Real-Time Payments (RTP).

System 100 is configured in accordance with an example embodiment a disclosed herein. System 100 includes user stations 110 and 121, which are shown, by way of example and not by way of limitation in FIG. 1, as a payer with a mobile phone 110 and a payee with a mobile phone 121. More expansively, however, user station 110 is operated by, under the authorization of, or on behalf of a payer or debtor (e.g., an individual, business, government, etc.), and user station 121 is operated by, under the authorization of, or on behalf of a payee or creditor (e.g., an individual, business, government, etc.). In this example, the payer or debtor may owe one or more debts to the payee or creditor. Accordingly, user station 110 can be referred to as a payer or debtor station, and user station 121 can be referred to as a payee or creditor station. Each user station may also be, for example, a personal computer, a tablet computer, a smartphone, a web enabled mobile computing device, a smart watch, a standalone computer terminal such as a kiosk or ATM, or any other suitable type of electronic device for receiving, transmitting, storing, and/or processing information.

System 100 also includes payer and payee financial institutions (FIs) 111 and 120 respectively, which are shown, by way of example and not by way of limitation in FIG. 1, as payer financial institutions 111 and a payee financial institutions 120. In an example embodiment, a user associated with station 110 can receive banking services (e.g., account services such as access to demand deposit accounts and savings accounts, brokerage services, and electronic bill payment and present services and the like) from payer FI 111. Similarly, a user associated with station 121 receives banking services from payee FI 120. Accordingly, payer FI 111 can be referred to as a payer or debtor FI, and payee FI 120 can be referred to as a payee or creditor FI. Each FI includes one or more computers and/or servers, such as, for example, the system of FIG. 1A, which are configured to handle electronic financial transactions and particularly real time payments.

Debtor station 110 is connected to (e.g., can electronically communicate with) debtor FI 111. Accordingly, the debtor may use station 110 to access banking services provided by FI 111 through, for example, an online banking portal available through a web browser running on station 110, banking software loaded on to station 110, or any other banking service provided by FI 111 on station 110. Similarly, creditor station 121 is connected to creditor FI 120. Station 110 and 121 also may connect to other elements as well, such as other elements of system 100.

Debtor FI 111 and creditor FI 120 are connected to each other by RTPS Technologies 130 which are incorporated herein. By way of example, and not by way of limitation, Debtor FI 111 and creditor FI 120 are connected to each other by an Automated Clearinghouse (ACH) network 130 (e.g., such as, without limitation, one or more of the Electronic Payments Network (EPN) and the FedACH). ACH network 130 can route (e.g., receive and transmit) electronic transactions and various types of messages between FIs via message interfaces as more fully disclosed in U.S. Pat. No. 11,042,882 which has been incorporated herein by reference. ACH network 130 can include one or more computers and/or servers which are configured to handle electronic financial transactions. ACH network 130 also can include one or more databases. The ACH network 130 is referred to herein, although in other implementations, real time payments from payer or debtor FI 111 to payee or creditor FI 120 are processed through one or more networks 130 by way of a real time payments system as a disclosed in one or more RTPS Technologies as are incorporated herein.

Each connection can be any suitable type of existing or later-developed connection between one or more computers (or computing devices). In one example, at least part of one or more of such connections may include a network such as a local-area network (LAN), wide-area network (WAN), or the Internet. For example, station 110 may be a computing device (e.g., a PC or smartphone) that connects, via the Internet, to one or more web pages maintained or hosted by or on behalf of Payer FI 111.

In one example embodiment, stations 110 and 121 can be connected by a secure communication channel (as indicated by the dashed arrow) on which communications may proceed after a single sign-on (SSO) procedure is performed in which a member using station 110 logs in to an online banking service provided by Payer FI 111, although this example is neither limiting nor exclusive. In such a procedure, Payer FI 111 can be configured as a SAML identity provider, and station 121 can be configured as a Security Assertion Markup Language (SAML) service provider. Accordingly, through communication between Payer FI 111 (as the SAML identity provider) and station 121 (as the SAML service provider), a secure communication channel between station 110 and 121 can be established. In one example embodiment, such a secure communication channel is provided by way of network 130, which enables the SSO procedure to be effected. Elements of system 100 can be configured to perform one or more of the steps or functions associated with any of the processes discussed herein, including those illustrated in the flow diagrams shown in the Figures and those discussed in connection therewith.

FIG. 1 shows a payer who is incentivized to make real time payment to a payee by way of a donor's offer 102 to a make a donation in exchange for the payer making a real time payment to the payee on an account 104 that was issued by a financial institution 111 to the payer 110. The account 104 that was issued by a financial institution 111 to the payer 110 can be one or more of a checking account, a saving account, a debit account, a gift card account, a stored-value (card) account, an account holding deposits of a type of digital currency for which records of transactions are maintained and new units of currency are generated by the computational solution of mathematical problems, and currency which operates independently of a central bank (e.g., bit coin), a revolving credit account where the financial institution bank extends new credit to the account holder whether or not the balance of paid off by the end of each periodic credit cycle, a charge account—e.g., similar to the operation of an original American Express account that had a periodic requirement to be paid off by the American Express account holder each cycle or else American Express would not extend new credit to the American Express account holder, a one-time-only ‘spot’ credit account, and a ‘line of credit’ account.

In some implementations, a Real Time Payment (RTP) from the payer to the payee may be referred to herein as a Peer-to-Peer (P2P) payment. The P2P payment may be quickly initiated and completed by use of a web-enabled mobile computing device (e.g., a smart phone) where a recipient of the P2P payment is identified by way of a logical address of a web-enabled mobile computing device (e.g., a cellular telephone number).

In various implementations, real time payments from payer or debtor FI 111 to payee or creditor FI 120 (e.g., Peer-to-Peer (P2P) payments) are processed through one or more networks 130 by way of a real time payments system as are disclosed in one or more Real Time Payment System (RTPS) Technologies incorporated herein. For a real time payment, there may be a ‘reduced exchange rate’ (e.g., less overhead will be assessed for making this type of payment, namely, a RTP—i.e., making a checking-account-to-checking-account low exchange rate payment in real time, as opposed to a ‘high exchange rate’ online credit card account payment). As an incentive to the payer to choose that the payment be made via RTP with low exchange rate payment processing, the payer financial institution bank may offer to make a donation to an affinity entity of the payer's choice (e.g., an affinity entity selected by the payer and/or the payee (e.g., the payer's or payee's favorite charity)). The donor, such as the payer and/or payee financial institution defines the donation (e.g., how the donation is made, when the donation is made, how much money the donation will be (e.g., the paying financial institution bank will make a donation of a certain percentage of the real time payment amount to the payee's favorite charity)). Preferably, the P2P payment will be a real time payment (RTP) for which a reduced rate exchange rate is incurred for making the P2P payment. If so, then the account of the payor account holder can be any of the following types of accounts: a revolving credit account where the financial institution bank extends new credit to the account holder whether or not the balance of paid off by the end of each periodic credit cycle; a charge account where additional credit is extended to the payor account holder after the credit balance of the account is paid off by the payor account holder; a one-time-only ‘spot’ credit account; or a ‘line of credit’ account.

As an incentive to the payer account holder to make the P2P payment to the payee account holder, one or both of the payer financial institution and the payee financial institution may make an offer to the make a donation to either or both of the payer's and payee's favorite charity. The donation may be derived from a business rule for making the donation. By way of example, the donation amount may be, at least in part, a percentage of the currency amount of the P2P real time payment. In one implementation, the payer account holder will make a designation of their favorite affinity entity by way of a logical address (a phone number, a geographic designator, etc.)

Within a predetermined audit time-period for and after a predetermined time-period, a plurality of donation receipts by a donor are received by the affinity entity selected by the payer, each including (i) the respective identifiers for the affinity entity or charity and the donor and (ii) a currency amount. For each identifier for the donor, the sum of the currency amounts of the donation receipts for each identifier for the affinity entity or charity is derived.

After the predetermined audit time-period for the predetermined time, for each identifier for the donor, and for each identifier corresponding to each affinity entity or charity to whom a donation was to be made as per the retrieved business rule, a determination is made of a difference between: (i) the donation for the predetermined time period that was transmitted to the logical address of the donor, and (ii) the sum of the currency amounts of the donation receipts received for the affinity entity or charity for the predetermined time period. Then, the determined difference is transmitted to the logical address for the donor, or its agent.

In other implementations, the affinity entities to which the donor donates can be limited to those within one or more of the payer's, the payee's, and the donor's community, within a specific community, within at least two (2) such communities, and/or within none of such communities. In still further implementations, the payer account holder can designate those affinity entities to which the donor is to make a donation, regardless of the location or charitable object or mission of the affinity entity. In yet other implementations, the donor can also make a donation to the payer's favorite charity. Other participants in a P2P payment processing can also define and make donations to the payer account holder's designated affinity entity, including the payer account holder, the payee account holder, the payor financial institution, the payee financial institution, and a sponsor who issued a stored-value account (i.e., a stored value or gift card) to the payer account holder.

In still further implementations, donations are made only when the donor is located in a particular community such as with the payee account holder's neighborhood, which may be defined geographically or by other definitions. The donations, for instance, are made to those affinity entities that have a physical location within a geographically defined community associate with the physical residence of the payee account holder.

In variations on the foregoing implementations, the identity of the payer account holder's designated affinity entity is not known or communicated to the payer financial institution, the payee account holder, or the payee financial institution. Such implementations leave the direction of donor's donations fully within the discretion of the payer account holder. In some implementations, the payer account holder's discretion can be limited by the restriction that the payer account holder can only select affinity entities from among those that serve the local community in common to the respective residents of both the payer and payee account holders, while leaving the actual amount of the donation fully within the discretion of the donor. Variations on such implementations include alternative definitions for the local community in common to both the payee account holder and the payer account holder.

In yet further implementations, a payer financial institution may allow a payee account holder to accept a P2P payment from an payer account holder without use of a payer credit account by way of technology that lets the payer account holder pay the payee account holder straight from the payor's checking account via an app installed on a web-enabled mobile computing device (e.g., a smart phone, smart watch, etc.).

Note that, in some implementations, the donor sets terms and conditions under which the donor will make the donation, while the payer selects those affinities entities to which the donor's donations are to be made. The donor may be one or more of a payer financial institution 111, a payee financial institution 120, the payee 121, and a sponsor who issued a stored-value (card) account to the payer.

Referring now to FIG. 1, a payer 110 with a mobile phone may initiate a real time payment to a payee 121 with a mobile phone. If the real time payment is authorized by payer financial institution 111, an entity 112 in the real time payment network 130, such as the payer financial institution 111, sends a message 116 containing particulars of the real time payment to a Web Service 101 indicating that the account of the payer account holder was approved for the real time payment. The real time payment thus triggers a donation by a donor to one or more affinity entities was selected by payer 110.

Optionally, the data input by payer 110 can include additional monies to be donated by the payer 110 that are also to be donated to a designated affinity entity or charity. In that case, message 116 would also contain these particulars.

Upon receipt of message 116, a donation to the affinity entity by the donor can be calculated according to terms and conditions specified by the donor.

Web Service 100 retains the derived donation for subsequent audit purposes to ensure compliance by each donor in its donation commitments to each of the one or more affinity entities or charities. The Web Service 100 may transmit a message 122 containing notice of a donation, or the particularly derived donation, as shown at reference numerals 118-120 to respective logical addresses of the donor, the affinity entities, and the payer 110—and/or to respective agents thereof. The terms and conditions that obligate the donor to make a donation may, but need not, include discounts, rebates, or other monetary or non-monetary incentives. As such, the payer 110 is incentivized to make a real time payment to the payee by the donor's agreement to donate to the payer's selected affinity entity or charity.

The affinity entity or charity, which may be selected at the discretion of the payer 110, may be any entity to which the payer 110 has an affinity, regardless of where it is located or whom it serves. Alternatively, the affinity entity or charity may be limited to those organizations that provide a good and/or service to a community in which both payer 110 and the donor have an affinity—such as by their common geographic location. This affinity entity may provide food and clothing to needy families in their common community. This affinity entity, for example, may provide teaching and demonstrations of entrepreneurial skills to community's unemployed or under employed. Another affinity entity may provide venues where sports education can be provided to local competing youth. Yet another affinity entity may provide care and feeding to abandoned domesticated animals, such as pets. The affinity entity may also cultivate desirable citizenship and public policy through offerings of education and entertainment services—whether in person, on-line, or both. Given the foregoing, the reader will understand that the affinity entity can be either a for-profit or a non-profit organization, and may optionally be required to provide a good or a service to a local community to which both merchants and customers in the same community have an affinity, by their common location, to advance and/or promote the community.

In some implementations, each donor will identity the affinity entity to whom the donor will make a donation. To identify the affinity entity, a payer 110 identifier, as received by Web Service 100 in message 116, will use a payer identifier (e.g., an account number) to look up the community where the payer 110 resides and where the donor has a brick and mortar geographic location. Web Service 100 uses information in or derived from message 116 to determine whether the donor and payer 110 have the same local community. By way of example, data in message 116 can include an identifier for the payer 110, and a database of donors and their respective donation rule can include geographic location information. This geographic location information is matched against the geographic location information for the residence of the payer 110. Donor and payer 110 identifiers can be assigned to the donor and the payer 110 during or prior to any real time payment, such as when each are registered with or otherwise sign up for participation with Web Service 100. This registration process can include the collection of physical and logical addresses for each or for their respective agents.

Once physical address information for the donor and the payer 110 are known, the local community of each of the donor and the payer 110 can be determined—in some implementations. The local community determination can be made on any of several different methods, or combinations thereof. Once such method is a political or legal division, that is, the donor's place of business is determined to be in the same political or legal division as that of the payer 110's residence, such as the same province, state, county, prefecture, city, city-state, borough, etc. Another such comparison can be whether the donor's place of business has a governmentally issued postal code that is the same, or within a predetermined proximity, as that of the payer 110's residence.

Yet another such comparison can be whether the donor's place of business and the payer 110's residence are physically proximate within a predetermined factor by any of a variety of measures or combinations thereof. For example, latitude and longitude coordinates might be known for both the donor's place of business and the residence of the payer 110. These coordinates can be used to determine whether the linear distance there between is within a predetermined distance to ascertain whether or not the donor and the payer 110 share the same local community.

Alternatively, a navigation algorithm, using any of various different travel methods (e.g., walking, automobile, bicycle, water taxi, mass transit, etc.), can be used, optionally in conjunction with real time traffic information, to determine whether the time, using one or more travel methods, is within a predetermined time limit to ascertain whether or not the donor and the payer 110 share the same local community or ‘neighborhood’. By way of example, the donor and the payer 110 might be determined to be within the same local community if the automobile drive time, as determined from one or more databases of contemporary cartographic road system information, to navigate between the donor's brick and mortar store and the payer 110's residence is less than a predetermined time threshold (e.g., 17 minutes).

A further alternative implementation will identify the population density of both the donor's brick and mortar store and the payer 110's residence. If the population density exceeds a predetermined density, then the donor and the payer 110 might be determined to be within the same local community if the time to walk, bicycle or take public transportation between the donor's brick and mortar store and the payer 110's residence, as determined from one or more databases of contemporary topographic, mass transit, and/or pedestrian cartographic system information, is less than a predetermined time threshold (e.g., 55 minutes). Such implementations may also access databases to consider real time traffic conditions.

Still another such comparison can be whether the donor's place of business and the payer 110's residence are proximate or are the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the donor and the payer 110, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the merchant and its customer are members of the same community, not members of the same community, or are both members of more than one of the same communities as determined by the algorithm.

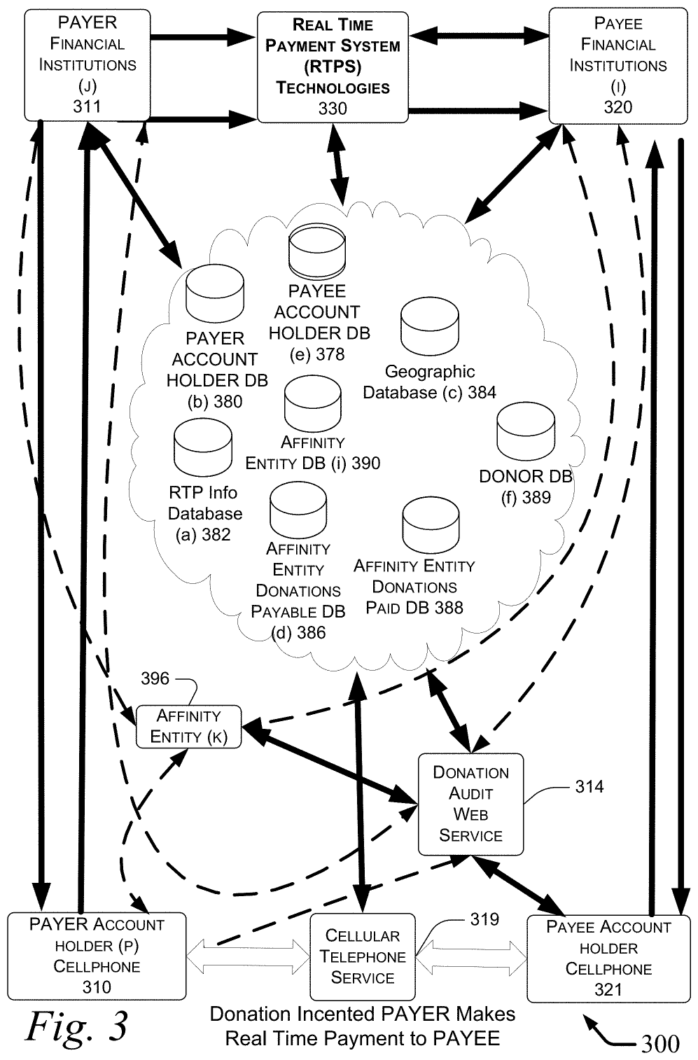

Similar or different algorithms that are used to determine the respective local community of the donor and the payer 110 can also be used to determine the local community of an affinity entity such as that shown on FIG. 1 at reference numeral 123, or as that shown as an Affinity Entity (i) 390 in FIG. 3, as discussed herein below.

In some implementations, if the local community of the donor, the payer 110, and an affinity entity that has been selected by the payer 110 or by other methods, are the same, then the business rule selected by the donor will determine the amount of the donation that the donor will make to the selected affinity entity. In some implementations, the affinity entity to whom a donor is to make a donation can only be selected the payer 110, and not the donor. In such implementations, the goals or purposes of an affinity entity will not cause tension between the donor and the payer 110 in that the identity of the affinity entity is unknown to the donor though being selected anonymously by the payer 110. As such, the donor need not be told or be given any notice, directly or indirectly, as to the identity of the affinity, entity or charity selected the payer 110. Rather, the donor might only be told or be given notice to make a single payment of, or period payments to, a single affinity entity who, as trustee or agent, will thereafter make respective disbursements for all registered donors accordingly to those affinity entities that had been selected those payers 110.

Various implementations can ensure that a donor who, by force of reason or conscience, does not want to make a donation to a particular affinity entity or charity, need not do so directly, as any and all donor donations are made blindly through other avenues or collection points that make all donor donation disbursements to all affinity entities or charities. Accordingly, each donor will have notice of its total periodic donations without knowing the identity of the intended recipients, thereby leaving the direction of donations fully within the discretion of the payer's 110. Note that a limitation can optionally be placed upon the payer 110's choice of affinity entity or charity such that the choice must be made only among those affinity entities or charities that serve the local community of the donor, the payer 110, or both. Such implementations may leave the currency amount of the donor's donation fully within the discretion of the donor.

Web Service 100 can use respective identifiers for the donor and the payer 110 (e.g., the payer account holder) to access and retrieve geographic information for each, and then apply an algorithm to the retrieved geographic information to determine the respective local communities of the donor and the payer 110, as discussed above. By way of example, the local community can be progressively granular in nature, such as: 1^{st} the United States of America; 2^{nd} the state of New York; 3^{rd} the portion of New York called “Long Island”; 4^{th} the county of Nassau within the state of New York; 5^{th} a portion of the Nassau County called North Hempstead; and then 6^{th} the specific geographic location of “Port Washington”. This final level of geographic granularity indicates a community in which both payer and payee are neighbors, residents, business brick and mortar operators, and/or the like.

The final level of geographic granularity can be used to perform a look-up against one or more databases to which Web Service 100 has access. This access and lookup is used by Web Service 100 to identify: (i) the affinity entity or charity for that community which, in this example, might be the Port Washington Food Bank located in Port Washington, N.Y., which charity might have been specified by the payer 110; and (ii) the respective identifier of the donor's business rule (and/or the payer 110's business rule) that is to be used to make a calculation of the currency amount of the donation that the donor is to make to the affinity entity or charity for that community. Business rule(s) is/are used with the currency amount of the payer 110's real time payment in order to calculate the currency amount of the donation that is to be made by the donor to the affinity entity or charity for that community. Note that the donation can be directed to a plurality of affinity entities for the local community according to directions that had been previously specified by the payer 110. For example, the payer 110 may have specified that each donor donation is to be split evenly, or in specified portions totaling one hundred percent (100%), between five (5) local community affinity entities, for example: (i) a local youth sports team cooperative; (ii) a local charter junior high school; (iii) a local house of worship; (iv) a local political party; and (v) a local for-profit college specializing business entrepreneurialism.

Note that terms and conditions of a donation that incents a payer to make a real time payment to a payee may differ. By way of example, the offer may obligate the donor to make a donation of a certain percentage of the entire currency amount of the real time payment, or the offer may obligate the donor to make a donation only if the real time payment is made at a certain time of day or on a particular day of the week, or only if the currency amount of the real time payment exceeds a predetermined amount, or a combination of the foregoing.

Although some terms of the offer by a donor to make a donation may differ from some terms of subsequent real time payments from a payer 110 to a payee 121, nevertheless, the donor's offer to make a donation to an affinity entity (e.g., a local charity) fundamentally provides an incentive that causes, at least in part, the payer 110 to make the real time payment for the benefit of an affinity entity located in the payer 110's residential community (in some implementations).

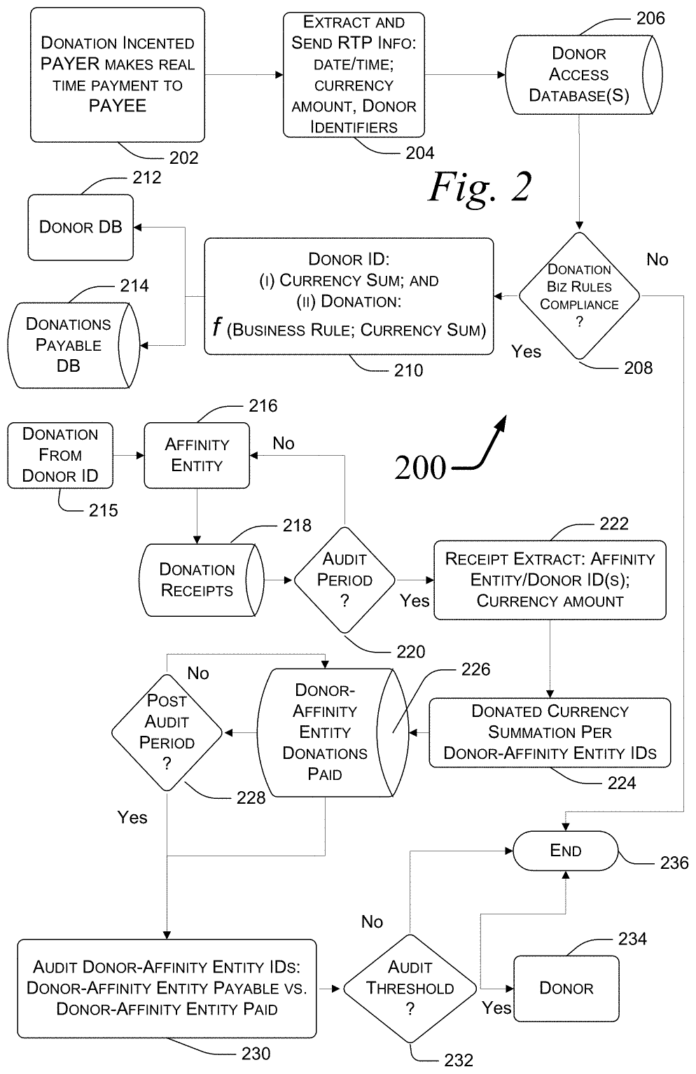

Referring to FIG. 2, a flowchart illustrates a Process 200 that can be performed by a system, such as a system including Web Service 100 in FIG. 1 and/or Donation Audit Web Service 314 seen in FIG. 3, for using donors' commitments to make charitable contributions as incentives to payers 110 to make real time payments. Prior to step 202 of Process 200, as discussed above with respect to FIG. 1, a payer 110 make a real time payment on an account issued by a payer financial institution 111 to the payer 110 to an account issued by a payee financial institution 120 to a payee 121. Prior to this real time payment, the payer 110 may receive one or more such offers 102 by donors to make a donation, either passively and/or actively by request.

At step 202 of FIG. 2, information is received as derived from real time payment authorization cycles as are disclosed in RTPS Technologies incorporated herein, upon which the real time payment is made by the payer 110 so as to trigger the donation by the donor who made offer 102 as described above with respect to FIG. 1. Data from this information can be extracted at step 204, including, by way of example and not by way of limitation, the date and time of the real time payment, a total currency amount of the real time payment at clearing and settlement on the payer 110's account, respective identifiers for the donor and the payer 110, etc.

Identifiers retrieved at steps 202-204 can be used to access one or more databases at step 206. The date and time for the real time payment can be compared to ensure the non-expiration of the offer made by the donor to the payer 110 in a query at step 208. While an invalid offer determination ends Process 200 at step 236, Process 200 proceeds to step 210 when the offer is valid as determined at query 208.

At step 210, rules for calculating the donor's donation are made for one or more affinity entity recipients via retrieval of information using data acquired in steps 202-204. These calculations can include steps to access one or more databases as shown at reference numerals 212-214, including transmitting to and/or storing the calculated donations in one or more donor databases 212 and/or in one or more merchant donations payable databases 214.

Subsequent to the real time payment on the payer 110's account as processed in steps 202-214 of Process 200, the donor makes the calculated donation to the local affinity entity as shown at step 215. The local affinity entity, as shown at step 216, sends notice of the donation's receipt for storage in one or more databases as shown at step 218.

After a predetermined audit time period as passed as determined by a query at step 220, an audit is conducted to insure compliance by each donor in its donation commitments to each of the one or more affinity entities or charities for which prior notice of such donations were provided to the donor. This audit can include adding up all required donations for each donor to each affinity entity or charity as shown at step 222. The donation summation for each donor to each affinity entity or charity derived at step 224 is compared to information in one or more databases 226 to ascertain compliance of each donor with its donation obligations. Stated otherwise, the donor has a certain amount of time after a predetermined audit period, as determined at step 228, by which to complete or make all of the donor's donation obligations to all affinity entities.

Differences between donations paid and donations still payable by each donor are calculated at step 230, which differences are subjected to an audit threshold query at step 232. If a donor's donations paid is non-compliant with donations still payable, as may be determined by the audit threshold query at step 232, then Process 200 moves to step 234 to notify the donor, or its agent, accordingly of its deficiency. Otherwise, affirmative results at query 232 causes Process 200 to terminate at step 236 which may also include notice of compliance being transmitted to each such complaint donor, the payers 110, and/or each of the local affinity entities. Each such notice can be either by way of summary report, donations to respective affinity entities by the donor, and variations thereof. Note also that progressive summaries of donations can be widely broadcast periodically incident to fundraising campaigns, capital development initiatives, and times of community need, thereby providing social motivation and incentives to an entire community of participating payers making payments to payee to help affinities entities simply by the payers participating in the making of real time payments to payees.

In other implementations, Process 200 includes the exaction of data from information derived incident to a positive authorization response for a real time payment on the payer 110's account, such as chronological information pertaining to the real time payment including date and time, a currency amount of the real time payment, and any other data desired to assist in a proper calculation of the donor's obligatory donation to affinity entity 216. By way of example, an identifier for the donor can be extracted, as well as an identifier for the payer 110 as offered to the donor by the same. The account number, by way of non-limiting example, can be a Primary Account Number (PAN) including a Bank Identifier Number (BIN) for a savings account, checking account, credit account, debit account, stored value account, and/or gift card account that are kept by the donor, for example in a ‘card-on-file’ database.

Note that, in various implementations, business rules can be set and used such that obligatory donations to Affinity Entity(ies) 216 can be made by one or more of the following participants in a real time payment system: the payer account holder, the payer account holder's financial institution, the donor, a financial institution who issued an account to a donor, and a handler entity for real time payments. Via access to one or more databases at step 206, and by using the donor and/or payer account holder identifiers extracted from the information derived from the positive authorization response for the real time payment, more information can be retrieved. Thereafter, database access can retrieve business rules used to calculate one or more donations that are to be made to the charities or affinity entities by one or more donors respectively corresponding to the payer account holder, the payer account holder's financial institution, the donor, a financial institution who issued an account to the donor, and an entity that processing data for the real time payment (e.g., the various steps of authorization, clearing, and/or settlement of the real time payment). Each such donation can be a function of the currency amount of the real time payment and the retrieved business rule(s).

In some implementations, donations, per extracted donor IDentifier (ID), are made for those real time payments that occur during a predetermined time-period and, optionally, within a predefined geographic location as determined by a query (not shown). If the result regarding a community, geography, or neighborhood query is affirmative, process 200 moves to step 210 where the donations that are to be made by the donor participants in the real time payment processing system are calculated as a function of the respective business rules. Otherwise, no donation is made and process 200 terminates at step 236. Stated otherwise, in such implementations, Process 200 is intended to obligate a donor to make a donation to a local affinity entity (e.g., a local charity) when a payer 110 makes a real time payment. Note that the terms ‘local’, ‘resident’, ‘residential’, ‘community’, neighborhood, and the like, can be alternatively defined as described elsewhere herein.

As in other implementations described above, donations calculated at step 210 are communicated to donor, or its agent, at step 212, and are stored in a donations payable database 214. Thereafter, donations 215 are received at affinity entities 216 at step 215 from donors identified by either respective donor IDs, which can be the identifier for the donor or for other real time payment processing system participants. Donations received are stored in donation receipts database 218. Data from donations that are made by donors via communication to affinity entities 216 during an audit period, as determined at query 220, is extracted at step 222. The donation-related data that is extracted at step 222 can include the donor ID, and the currency amount of the donation. During the audit period, a sum of donations to each affinity entity 216 made by each donor for the audit period is calculated and stored in a donor-Affinity Entity donation paid database 226. After a predetermined time period, an audit period begins, as determined by query 228. During the audit time period, differences in donations paid are compared to donations payable for each donor at step 230. Differences exceeding a predetermined audit threshold, as determined by query 232, are communicated to the respective donors, or their respective agents, at step 234. Of course, the charitable audit functions, such as have been described above, can be performed by an agent of any donor and/or of a loyalty system organization charged with implementing all or portions of process 200. Such an auditing agent can be, by way of non-limiting example, a certified public accountancy agency, a non-government regulatory agency, a governmental agency, and the like.

As further discussed above with respect to various implementations, a donation mechanism can be set up such that the donor makes blind donations, either directly or indirectly, to a single donation disbursement entity who in turn disburses the donations to those affinity entities selected by the payers 110. This donation mechanism provides neither knowledge nor notice to the donor as to the identities of its donation recipients, thereby avoiding circumstances that force a donor, by virtue of its prior commitment, to donate to a local community affinity entity or charity whose role or purpose is inimical or otherwise repugnant to the donor. As such, the donation mechanism leaves the direction of the donor's donation fully within the discretion of the payer 110, limited only, in some implementations, by the restriction that the payer 110 can only select from among those affinity entities or charities that serve the local community that is in common to both the payer 110 and the donor, while leaving the actual currency amount of the donation fully within the discretion of the donor.

Referring now to FIG. 3, an exemplary process 300 is depicted of a particular real time payments system in which a payer 310 makes a real time payment to a payee 321. The payer 310 is incented to make the real time payment to the payee by a donation from a donor. The donation by the donor that incents the payer 310 to make the real time payment is the donor's agreement to make a donation to an Affinity Entity (k) 395, which affinity entity may be associated with a geographic location within the local community as defined by the payee 321 through an advertisement incentive which, optionally, can be communicated to the payer 210, whether requested or not.

In FIG. 3, by way of explanation for the nomenclature of reference numerals used and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements in FIG. 3 are illustrated with a block, but may indicate that one or more elements can be present. For example, each symbolic data base depicted in a network cloud shown in FIG. 3 may include one of a possible plurality of data bases.

A payer makes a Real Time Payment (RTP) via an electronic payment device 310 (i.e.; a smart phone) to a payee for delivery to an electronic payment device 321 (i.e.; a smart phone). The RTP from the payer to the payee may be a simple person-to-person transfer of funds, or may be a payment to a merchant-payee as tender for a financial transaction such as a purchase of goods and services. The function and operation of each such real time payment is by way of RTPS Technologies incorporated herein and shown by RTPS 330 in FIG. 3. The payer's funds of the real time payment are held by a payer financial institution 311 in any of a funds holding account such as a checking account, a savings account, a stored value account, a debit account, a credit account, etc.

Payer financial institution 311 and Payee financial institution 320 are licensed to operate within any network system facilitating one of the RTPS technologies as incorporated herein, including the processing of authorization cycles for each real time payment from a payer to a payee.

Also shown in FIG. 3 are one or more Affinity Entities (k) 396 and a Donation Audit Web Service 314 that implementations processes by which donations are made by one or more donors to the one or more Affinity Entities (k) 396. For instance, a donation can be made by any of the payer, payee, the respective financial institutions (j) 311 and (i) 310 of the payer and payee, and even by one or more entities within the RTPS 330. Donation Audit Web Service 314 implementations processes for the auditing of donations to the one or more Affinity Entities (k) 396. The Donation Audit Web Service 314 has access to information resources within the following databases: Payee Account Holder DB (e) 378; Payer DB (b) 380; Real Time Payment (RTP) Database (a) 382; Geographic Database (c) 384; Affinity Entity Donations Payable database (d) 386; Affinity Entity Donations Paid database 388; Donor Database (f) 389, and Affinity Entity Database (i) 390.

By way of example, and not by way of limitation, construction of local, geographic, residential or community associations between payers and payee can include factors such as geographic, political, demographics, local transportation modes, navigational algorithms for geopolitical regions, cartographic data, planned communities, population density, cultural divides, racial population constituencies, census statistics, socio-economic factors, and combinations thereof.

As shown in FIG. 3, Databases 378-390 can be connected by one or more private or public networks, virtual private networks, the Internet, or by other means known to those skilled in the art. Moreover, not every entity seen in FIG. 3 must necessarily have real time, uninterrupted access to any or all of the Databases 378-390. Each such Database 378-390 can assign, read, write, and query permissions as appropriate to the various entities.

Each RTP Database (a) 382 can be designed to store some or all of the real time payment data associated with accounts issued by financial institutions 311 and 320 to payers and payees, including date of each RPT, time of each RPT, physical geographic location of each payer and payee, and an identifier sufficient to determine a physical geographic location where the RTP took place, among other more specific information including the amount of the RTP. The database can be searched using account information, date and time (or within proximity thereof), or by any other field stored in the database.

Also included in the RTP Database (a) 382 are account information for payment devices associated with payer in database (b) 308, such as part or all of an account number, unique encryption key, account information, and account name of a payer account holder who is registered to participate in a system in which donations can be made to each Affinity Entity (i) 390 as per rules stored in Payee Database (e) 378. After registering to participate in the donation system, a payer (p) can use a cellphone 310 to initiate a real time payment to a payee via the payee's cellphone 321, which real time payment is to be processes by any of the RTPS Technologies incorporated herein and shown in FIG. 3 as RTPS 330. The real time payment information can include payer account information, payer account name, payer account balance, real time payment time, real time payment date, and real time payment location. Sensitive information can include information such payer account number and payer account holder name that identify and associate a particular account with a particular payer account holder. This real time payment information may be transmitted via a less secure communication medium. In addition, a transmission of real time payment data may occur with weak or no encryption between two or more points from the point of origin. The communication channel could be Ethernet, wireless internet, satellite, infrared transmission, or other known communication protocols as are disclosed in the RPTS Technologies incorporated herein. Some or all of the transmission may also be stored for record keeping, archival or data mining purposes with little or no encryption.

For a donor to donate to each Affinity Entity (i) 390 as may have been previously specified, one or both of Payer Financial institution (j) 311 and Payee Financial institution (i) 320 can pay the Affinity Entity (i) 390.

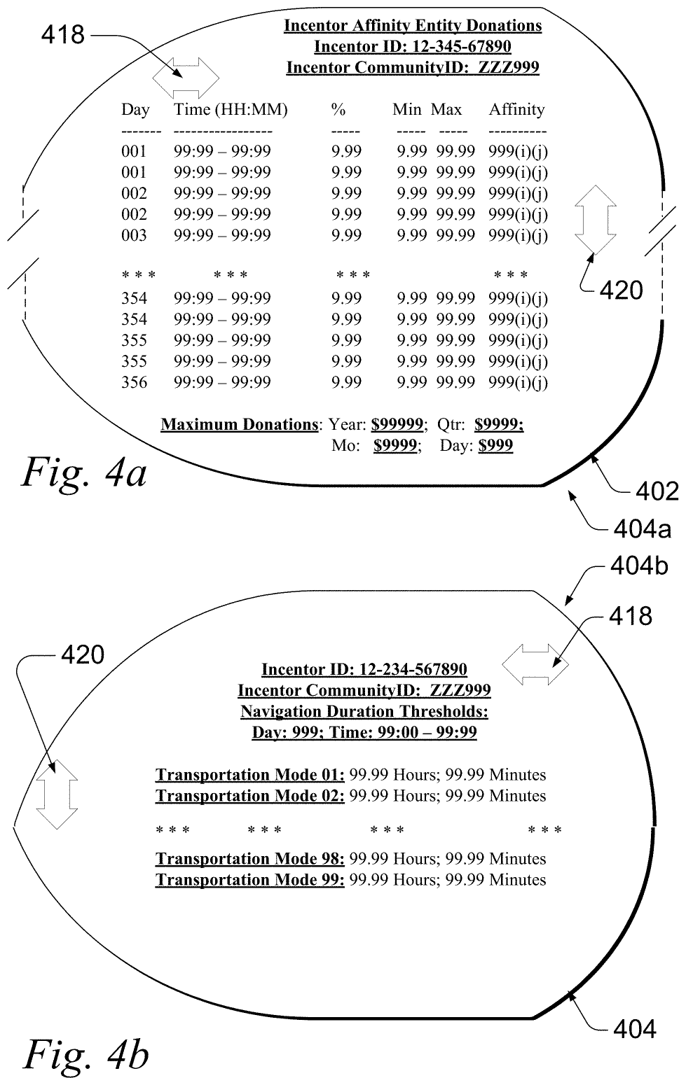

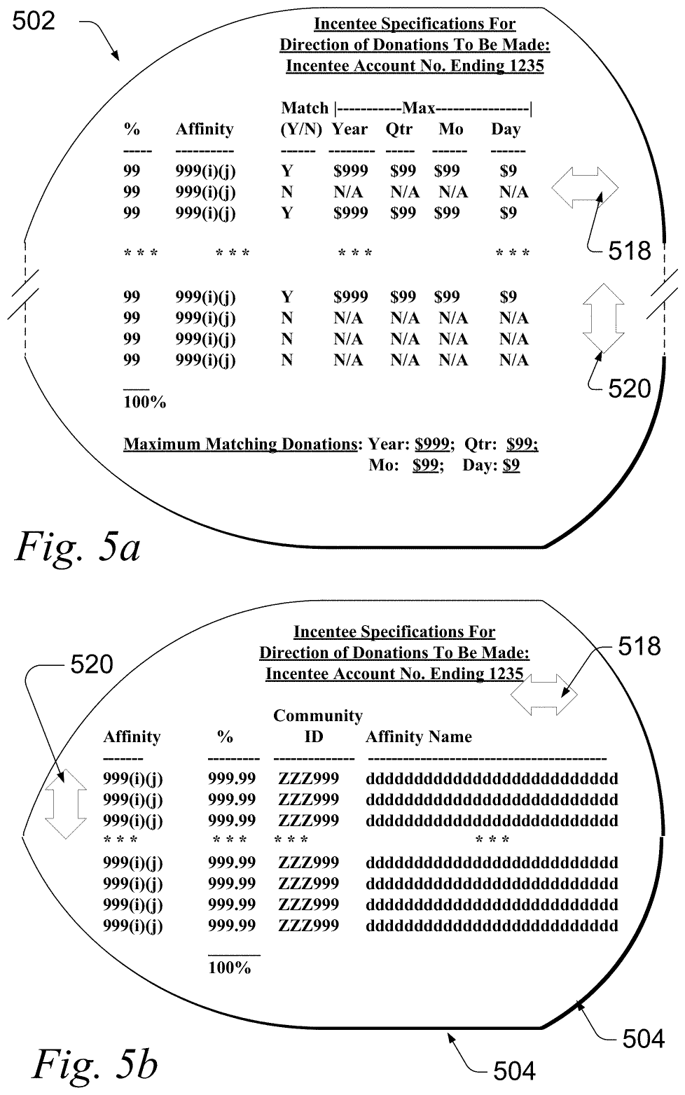

As discussed below with respect to the exemplary user interfaces FIGS. 4a-5b, both payer and payee can change or disable a donation commitment at any time by accessing a server that serves web pages where respective user interfaces are provided. Thus, charitable donation commitments can be enabled or disabled using real time user interfaces. By way of example, and not by way of limitation, such servers can be hosted by the Donation Audit Web Service 314 seen in FIG. 3.

In various implementations, Donation Audit Web Service 314 seen in FIG. 3 receives information that confirms such a real time payment from a payer to a payer by way of receiving information derived from RTPS 330. Once confirmation has been received by Donation Audit Web Service 314 that the real time payment has taken place, a calculation is made of an amount of a donation that is to be made by a donor according to terms of the offer. By way of example, the terms of the offer to make the donation to the community affinity entity or charity 396 may have been previously input for storage in Payee Account Holder DB (e) 378 by way of a user interface provided by an application executing on a computing device, such as in conjunction with a screen shots 402-404 seen in FIGS. 4a-4b as described herein below. To give notice of the donation obligation that has arisen, the calculated donation can be sent in one or more transmissions from Donation Audit Web Service 314 to one or more logical addresses associated with entities depicted in FIG. 3 at reference numerals 310-321, or to respective agents thereof. Optionally, information that identifies the Affinity Entity (i) 390 and/or Payee Financial Institution (i) 320 can be included in any such transmission.

Where the payer's designated Affinity Entity (i) 390 to which a donor is obligated by a real time payment from a payer to a payee to make a donation is specified by the payer (e.g., such as by use of a user interface having a screen shots 502-504 seen in FIGS. 5a-5b, respectively), the identity of the Affinity Entity 396 need not be communicated to either or both of the payee and donor. Rather, either or both of the payee and donor can make a blind donation of the calculated amount to a third party for distribution to the Affinity Entity (i) 390 in a residential community as designated by donation rules specified by the donor. By such blind, albeit obligatory, donations, conflicts and disagreements between payer and payee as to right and proper objects of charity or affinity to the community can be avoided. As such, the payer will make a real time payment to a payee by way of incentives from donors that they will donate to the payer's designated Affinity Entity (i) 390), though the payer's designated Affinity Entity (i) 390 may not be that of the payee, or even a desirable charity, in that community. Nevertheless, the payee has received the benefit of the payer's real time payment in order to have access to instant liquidity of the payer's payment, where the benefit to the payee is incented by the payee's offer to the payer to make a donation to the payer's designated Affinity Entity (i) 390 as specified by the rules of the donor's obligation to make the donation.

Referring now to FIGS. 4a-4b, screen shots 402-404 feature input capture and rendered display fields by which an incentor, or agent thereof, can input terms and conditions under which a donor is willing to become obligated to make a donation to an Affinity Entity (i) 390 when a payer makes a real time payment to a payee. The incentor, or agent thereof, can be the donor, or a third party who itself has an incentive to profit or otherwise benefit when a payer makes a real time payment to a payee. As such, the incentor, or agent thereof, may be one or a combination of participants in a real time payment system facilitated by any of the RTPS Technologies, including: (i) the payer; (ii) the payee; (iii) the payer financial institution; (iv) the payee financial institution; (v) a sponsor who funds an stored value account from which real time payments are to made by a payer to a payee; (vi) an consortium of merchants located in a predetermined geographic area who want to receive real time payments as payees in exchanges for goods and/or services delivered to payers who conduct transactions with those merchants; and (vii) any third party donor who incents a payer to make a real time payment to a payee by the incentive of making a donation to an affinity entity.

Each row in screen shots 402-404 represents all or a portion of the twenty-four (24) hour day of the 356 calendar days of one (1) year. Columns in each row of the table seen in screen shot 402 are, from left to right, as follows: 1^{st}: the numerical calendar day of the year; 2^{nd}-3^{rd}: the hyphenated starting and ending of a time period within the calendar day; 4^{th}: a percentage of a currency amount of any one real time payment that a donor will commit to make to an Affinity Entity (i) 390; 5^{th}: the minimum currency amount of the real time payment before the commitment by the donor to make the donation will arise; 6^{th}: the maximum amount of donation that the donor is willing to make for any one (1) real time payment; and 7^{th}: an identifier for the Affinity Entity (i) 390 to whom the donor is to make the donation as described in the row. Note that, in some implementations where the payer selects Affinity Entity (i) 390, then the seventh column may not have data entered. In other implementations, the seventh column is a constant affinity entity that does not change, for example, where the affinity entity is not changeable (e.g., the American Red Cross of the Greater New York Region, USA; the Edmonton Minor Hockey Association for the City of Edmonton, Alberta, Canada; etc.) The bottom of screen shot 402 allows specification inputs for the donor as to its maximum donation across all Affinity Entities 390 (i) for any one day, month, quarter of a year, or year.

By way of example, and not by way of limitation, the data input by the incentor, or agent thereof, for display on screen shot 402 can obligate a donation to be made to Affinity Entity (i) 390 that is higher at some days and times of the calendar year, and lower at other days and times of the calendar year. As such, by way of example and not by way of limitation, it may be advantageous for the incentor to provide proportional incentives by way of a higher donation incentive for typical slow business time-period of different calendar days and a lower donation incentive for typically busier business time-period of different calendar days, or to for the incentor to provide proportional incentives by way of a higher donation incentive for time-periods of different calendar days when there is a greater need for liquidity and immediate access to cash and a lower donation incentive when there is a lower need for liquidity and immediate access to cash.

Referring now to FIG. 4b, much of a payer's spending may occur near the physical address of the payer's residential home or place of business. As such, it may be economically desirable for an incentor to provide an obligation by a donor to make a donation as an incentive only to those payers who are residents having a physical address that is close enough to be regularly incented by the incentor's offer for a donor to make a donation with the payer's real time payment to a payee, while not offering this incentive to other payers who would be unlikely, due to physical separation, to regularly make real time payments to payees due to the payee being outside of a predetermined geographic proximity. Accordingly, and depending upon factors such as the demographics, population density, affluence, etc. of the physical location of the payee to whom the payer is to make a real time payment, the incentor may use the user exemplary user interface 404b in FIG. 4b to input different navigation ranges for different likely-to-be-frequent payers according to any of the transportation modes that these potential-frequent payers are likely to take should these payers know and understand the incentive input by the incentor for a donor to make a donation to an affinity entity when the payer make a real time payment to a payee. Accordingly, the incentor may input at screen shot 404 any of various different travel methods (e.g., walking, automobile, bicycle, mass transit, etc.) and navigation time ranges, which mode is indicted in FIG. 4b as a two (2) digit transportation mode.

Screen shot 404 allows an incentor, or its agent, to input one more minimum and maximum navigation times for different times on different days of the year. Each input navigation time range is used to determine whether or not a donor will be obligated to make a donation to an affinity entity (e.g., a charity). In practice, information derived from a real time payment conducted using any of the RTPS Technologies is obtained. This information will contain sufficient data that can be further used to retrieve and/or determine physical address information for the payer and the payee. Once physical address information for the payer and the payee are known, these physical addresses are used with a navigation time algorithm to determine the navigation time between the physical address of the payer to the physical address of the payee. If the determined navigation time is within the input minimum and maximum navigation times for one or more transportation nodes seen in the middle of screen shot 404 in FIG. 4b, and the date and the date and time of the real time payment by the payer to the payee are within a time period and day as provided by the incentor's input as seen at the top of screen shot 404, then the donor will be obligated to make a donation to an affinity entity (e.g., a charity). Otherwise, the donor is not obligated to make a donation to an affinity entity (e.g., a charity).

The one or more different transportation modes seen in screen shot 404 of FIG. 4b each show minimum and maximum navigation times for different transportation modes as are indicted by two (2) digit codes. One such transportation mode can be by automobile, another by walking, and other by mass transit, another by a specific combination of different transportation modes (e.g., walk, subway, bus, and walk), etc.

Any of various navigation algorithms, both known and yet to be developed, can be used to determine whether the time, using one or more travel methods, is within the incentor's input navigation time range. The result of the algorithm's determination will ascertain whether or not the payee and the payer making a real time payment to the payee share the same local community or ‘neighborhood’, and if so then a donor will accordingly be obligated to make donation when the payer makes a real time payment to the payee (e.g., for instance, when a payer-customer buys something from a payee-merchant). By way of example, the payee-merchant and its payer-customer might be determined to be within the same local community if the automobile drive time, as determined from one or more databases of contemporary cartographic road system information, which information may incorporate real time traffic information, to navigate between the payee-merchant's brick and mortar store and the payer-customer's residence is less than a predetermined time threshold (e.g., 17 minutes). The navigation algorithm used with the input from screen shot 404 and the respective physical addresses of payee-merchant and the payer-customer holder can be varied.

As stated above, the majority share of a payer's annual spend, at least for some communities, tends to stay in the payer's local community, a payee in that community, or other incentor, would like to incentivize residents in that community to make real time payments to payees. As such, the payee that is associated with a geographic location or residence in a heavy-local spending community can choose to incent payers to make real time payments by way of an offer to any such payer who is a community resident, where the incentive that is offered to the payers is that a donation will be made by a donor to one or more affinity entities or charities that are designated by the payer who is a community resident. The donor's donation, however, can be made conditional. One such condition can be that the payer be a community resident who resides in the community where the real time payment is to be made for a transaction for goods and/or services is conducted with a payee-merchant—where the community residence criteria are made upon a derivation of a specific navigation algorithm. A commercial reason behind the donor's donation incentive is to attract payer-customers who are likely to be repeat payer-customers who will frequently shop at payee-merchants' brick and mortar stores. Although somewhat dependent upon the type of goods and services provided by the payee-merchant, and the geographic location where the payee-merchant is physically located, the type of payer-customer that is most likely to be a repeat, frequent payer-customer might be determined to be one who lives or works relatively close to the payee-merchant's brick and mortar store. As such, screen shots seen in FIGS. 4a-4b provide input fields to receive an incentor's incentives directed towards likely frequent payer-shoppers, while disallowing a donation incentive to payer-customer who will be unlikely to travel to the payee-merchant's store frequently due to distance, difficulty of the commute, etc.

In some implementations, the obligation for a donor to donate to an affinity entity when a real time payment is made from a payer to a payee can be tested in a variety of ways. One test for the payer's residence can be made by calculating the duration of a trip to navigate from a geographic location associated with community resident to a geographic location associated with the payee. This calculation can be made by using one of more navigation time estimation algorithms. Stated otherwise, the duration of a trip to navigate from a geographic location associated with a payer to a geographic location associated with a payee can be calculated by using one of more navigation time estimation algorithms. By way of example, and not by way of limitation, any of the following algorithms, either alone or in combination, can be used when calculating a navigation time between places respectively associated with payer and payee: (i) Depth-First-Search (DFS); (ii) backtracking search; (iii) Dijkstra's algorithm; (iv) Krushkal's algorithm; (v) Prim's algorithm, (a.k.a. DJP algorithm; (vi) the Jarnik algorithm or the Prim-Jarnik algorithm; (vii) Reverse-Delete algorithm; (viii) Borůvka's algorithm; (ix) a navigation algorithm now conceived; (x) a navigation algorithm both conceived and reduced to practice; and/or (xi) a navigation algorithm that is developed in the future.

Another way to calculate navigation time between places respectively associated with the payer and the payee is to outsource calculations to a public or private web service by transmitting the respective geographic place identifiers to an online navigation service for calculation of navigation time and receive by the navigation time estimate. By way of example, the pair of places can be sent to an online service for subsequent return of a navigation time estimate as are provided by a Google® maps service, a Bing® maps service, a Garmin® maps service, a Delorme maps service, a TomTom® maps service, a Mapquest® maps service. The navigation time estimate calculated, or received back from a web mapping service, can be a time for one or more transportation modes, including but not limited to walking, automobile or taxi, bicycling, snow machine, boat, mass transit, or a combination thereof.

As shown in FIGS. 4a-4b, an incentor can designate, if each of several different time periods during each calendar day, the navigation time under which a donor will make a donation to one or more affinity entities (e.g., charities) designated by a payer who make a real time payment to a payee, as well as the corresponding percentage of the real time payment amount that the donor will donate. As such, an incentor can input data such that a greater or lesser donation is made as depends up the time, the day, and the navigation time, by any of several different modes of transportation, between locations respectively associated with the payer who makes a real time payment to the payee.

In the case of a geographic area having a high-density population (e.g., a city), an incentor may input small navigation times because local payer-shoppers live close to the payee-merchant's location. As such, the donor is thereby committing to donate only those affinity entities (e.g., charities) designed by payer-customers who live close to the payee-merchant—such as in ‘walking distance’. Alternatively, in rural and sparsely populated areas, the incentor may input larger navigation times because local payer-shoppers are likely to drive in an automobile as the most reasonable transportation mode to arrive at the payee-merchant's store. As such, the payee-merchant is thereby committing to donate only those affinity entities (e.g., charities) designed by payer-customers who live close enough to drive a reasonable distance to the payee-merchant's store.

An incentor may choose to establish an incentive whereby a donor will not make a donation to any affinity entity for any real time payment from a payer to a payee when the payer is identified with a residence or location that is too far from the payer's location to represent potential frequent repeat real time payments. As such, input of incentices by an incentor to exemplary user interfaces 402, 404 in FIGS. 4a-4b, respectively, would be unfavorable towards any donation to designated affinity entities (e.g., charities) of a payer who is unlikely to regularly make real time payments to a payee to due geographically undesirable navigation times there between.

The navigation time input by the incentor might preferably be dependent upon the types of goods and services provided by a payee-merchant. Payee-merchants offering only commodity items, such as grocery stores, would be like to cause incentors to input shorter navigation times than incentors acting on behalf of payee-merchants who typically providing rare and hard-to-find items for which payer-customers are more likely to be willing to make longer commutes in order to make purchases from such payee-merchants.

FIG. 4b allows an incentor to input different navigation time thresholds for any of several different kinds of transportation modes, such as walking, driving, mass transit, and their combinations, which modes are indicated by two (2) digit codes. For instance, if at least one of the navigation times from a payer-customer's residence to a payee-merchant's brick and mortar store for different transportation modes is less that an input threshold, then a donor will make donation the payer's identified affinity entities (e.g., charities) after the payer-customer makes a real time payment to a payee-merchant incident to a transaction for goods and/service with the payee-merchant as processed by any of the RTPS Technologies.

The local community of each of the payer and the payee can be determined in still other ways in other implementations, where the donor's obligation to donate will not be fixed unless the respective physical addresses of payer and payee are in the same community or neighborhood according to a predetermined algorithm. Any such local community determination can be made in any of several different methods, or combinations thereof, according to the donor's preference as to what algorithm is mostly likely to attract the most favorable, such as a desire to attract potential payer foot traffic to a geographic location proximate to that of one or more potential payee-merchants' brick and mortar stores. One such method is a political or legal division, that is, the payee-merchant's place of business is determined to be in the same political or legal division as that of its payer-customer's residence, such as the same province, state, county, prefecture, city, city-state, borough, etc. Another such comparison can be whether the payee-merchant's place of business has a governmentally issued postal code that is the same or within a predetermined proximity as that of its payee-customer's residence. Yet another such comparison can be whether the payee-merchant's place of business and its payer-customer's residence are physically proximate within a predetermined factor by any of a variety of measures or combinations thereof. For example, latitude and longitude coordinates might be known for both the payee-merchant's place of business and the residence of its payer-customer. These coordinates can be used to determine whether the linear distance there between is within a predetermined distance to ascertain whether or not the payee-merchant and its payer-customer share the same local community.

A further alternative implementation will use an algorithm that uses the population density of the payee-merchant's brick and mortar store and the payer-customer's residence, as well as real time transportation data such as traffic conditions, bus and subway availabilities, etc. If the population density exceeds a predetermined density, then the payee-merchant and its payer-customer might be determined to be within the same local community if the time to walk, bicycle or take public transportation between the payee-merchant's brick and mortar store and the payer-customer's residence, as determined from one or more databases of contemporary topographic, mass transit, and/or pedestrian cartographic system information, is less than a predetermined time threshold (e.g., 55 minutes).

Still another such comparison can be whether the payee-merchant's place of business and its payer-customer's residence are proximate or the same according to voting, electoral, or political districts. The district use can be determined by an official method, an unofficial method, or a combination of methods. By way of example, measurements known within the political gerrymander sciences can be used, including but not limited to a minimum district to convex polygon ratio, shortest split line algorithm, minimum isoperimetric quotient, etc.

The local community corresponding to that of the payee-merchant and its payer-customer, and separations there between (if any), can be determined from any combination of linear distance, mode-specific navigational transportation travel time, political separation, postal designation, and/or hybrid algorithm that takes into considers geographic barrier features such as rivers, cliffs, and highways, cultural features such as boundaries of identified people groups (e.g., tribes, first nation people, etc.), land ownership such as subdivisions, housing projects, cooperatives, planned communities, military installations, governmental owned and leased properties, etc. Given the foregoing, an algorithm might find that the payee-merchant and its payer-customer are members of the same community, not members of the same community, or are both members of more than one of the same communities as determined by the algorithm.

Similar or different algorithms that are used to determine the respective local community of the payee-merchant and its payer-customer can also be used to determine the local community of an Affinity Entity (i) 390 in FIG. 3, as discussed herein below. These determinations can be performed when a donation term is conditioned upon the location, neighborhood or community of the Affinity Entity (i) 390.

Data input in the exemplary user interfaces depicted by screen shots 402-404 can be stored in one or more of network data bases 378-390 or other location logically accessible, via one or more networks or otherwise, to Donation Audit Web Service 314. These data can also be automatically pre-loaded for network data bases 378-390 via an automatic initiating service (e.g., an data auto-boarding or auto-populating operation) that allows network data bases 378-390 to be automatically entered, where applicable, as payers 310 in a local community charitable donation program that incentivizes increased local payer 310 resident foot traffic to each geographic location of payees 321 in the local community. Note that auto-boarding allows small and medium sized payees 321 to enter such a program with little or no effort by using default data in auto-populating information to be used for the payees 321 participation in the program in which a donor makes a donation to an affinity when a payer makes a real time payment to a payee.

As seen in FIGS. 4a-4b, each offer input by an incentor for a donor to make a donation to an affinity entity is not be specific to a particular good or service that a payee-merchant may provide to a payer-customer in a transaction paid for via a real time payment from the payer to the payee as process by any RTPS Technologies. Rather, the offer by the donor to make the donation to the affinity entity is specific to the entire transaction between the payee-merchant and its payer-customer. By way of example as to this type of offer specificity, the offer by the donor may obligate the donor to make a donation of a certain percentage of the entire currency amount of the real time payment from the payer to the payee, or the offer may obligate the donor to make a donation only if the real time payment was made a certain time of day or on a particular day of the week, or a combination of the foregoing. Although some terms of the offer by the donor to make the donation may differ from some terms of the real time payment from the payer to the payee, nevertheless, a donor's offer to make a donation to an affinity entity (e.g., a charity) has the goal of fundamentally providing an incentive that causes, at least in part, a payer to navigate to a geographic location at which the payee is located (e.g., a local payee-merchant's brick and mortar store as new payer foot traffic), and ultimately for the payer to make a real time payment to the payee so as to provide to the payee liquidity and ready access to cash.

By way of exemplary implementation of data input to a field in screen shot 402, a received identifier might identify a specific Affinity Entity (i) 390 as shown in FIG. 3 that is located in, and provide goods and services to, the borough of Greenwich Village at the southern portion of the geographical island of Manhattan in the city of New York of the State of New York, in the USA. By way of example, and not by way of limitation, an Affinity Entity Code having the character string “105(064) (q2e)”, which would be input in the 7^{th} column of screen shot 402, could have an interpretation where ‘105’ represents the United States of America, the index ‘064’ represents the state of New York, “q” represents the City of New York, “2” represents the combined boroughs of Manhattan, and “e” represents the borough of Greenwich Village at the southern portion of the geographical island of Manhattan in the city of New York of the State of New York. The name of the specific Affinity Entity (i) 390 represented the character string “(105) (064) (q2e)” can be the Washington Square Food Bank, which may be located in, and provide goods and services to, the borough of Greenwich Village at the southern portion of the geographical island of Manhattan in the city of New York of the State of New York, in the USA.

Note that an incentor can use screen shot 402 to specify multiple community IDs each representing a geographic location where one or more of the payer and payee either has a residence or operates a business in the geographic location. Also note that, for each such community ID specified by the incentor, the second column of the rows of screen shot 404 in FIG. 4b will preferably add up to 100%, thereby provide a percentage the donation made by the donor when a payer makes a real time payment to a payee as facilitated by any of the RTPS Technologies incorporated herein.

For screen shots 402-404, input and selection of data for each Affinity Entity can be via a typical user experience including but not limited to keyboard data entry, pull down menus, pictograph optical scanning with a cellular telephony device as read from print or electronic media rendering, etc. Horizontal 418 and vertical 420 panning can be user activated to move that portion of the display being rendered horizontally and vertically, respectively.

Referring now to FIGS. 5a-5b, a screen shot 502 features input and displays fields by which an incentee, or agent thereof, can direct a third party donor to become obligated to make a donation to an Affinity Entity (i) 390 when a payer makes a real time payment to a payee using any of the RPTS Technologies incorporated herein. Alternatively, or in combination, these data fields can be auto-populated in an auto-boarding process that facilitates immediate participation by payers and payees. Each row in screen shot 502 represents a different Affinity Entity (i) 390. Other donors so directed by the incentee's data entry can optionally include one or more participants in a real time payment system, including: (i) the payer; (ii) the payee; (iii) the payer financial institution; (iv) the payee financial institution; (v) a donor who incents the payer to make a real time payment to the payee by making a donation to an affinity entity selected by the payer; and (vi) an operator of a real time payments system making a donation on behalf of a third party (e.g.; An operator of a real time payments system, such as Fiserv, Inc., who provides financial technology and financial services to a variety of clientele including banks, thrifts, credit unions, securities broker dealers, leasing and finance companies, and retailers, on behalf of a clearing house (e.g., A clearing house, such as “The Clearing House”, having a place of business on the 17th Floor, 1114 A venue of the Americas, New York, N.Y. 10036, which is a designated intermediary between a buyer and seller in a financial market, where the clearinghouse validates and finalizes transactions to ensure that both the buyer and the seller honor their contractual obligations. Every financial market has a designated clearinghouse or an internal clearing division to handle this function.)). Each of the foregoing entities, (i) through (vi), can similarly also make donations to one or more affinity entities that have been selected by any one or more of the foregoing entities, (i) through (v), as yet further incentives to the payer to make a real time payment to the payee.

The affinity entities shown in FIGS. 5a-5b are expressed in each row by an integer indexed in both T and ‘j’ variables. By way of example, such an indexing system might identify a specific affinity entity by the code 105(064) (q2e), where ‘105’ represents the international charitable organization “United Way”, the index ‘064’ represents that organization's affiliated charity within the United States of America, and the index ‘q2e’ represents the borough of Greenwich Village at the southern portion of the geographical island of Manhattan in the city of New York of the State of New York.

Other columns in each row of the table seen in screen shot 502 are, from left to right, as follows: 1^{st}: the percentage of the donor's donation that the incentee directs to be donated to the affinity entity (e.g., charity) identified in the 2^{nd} column; 3^{rd}: a yes or no indication whether the payer will match the donor's donation to that charity; and the 4^{th} through the 7^{th} columns: the maximum currency amounts that the payer will commit to give to the identified charity for the current year, quarter, month and day, respectively. The bottom of screen shot 502 allows an incentee to specify the maximum total of all matching contributions will make to all affinity entities (e.g., charities) that the payer is willing to commit for the current year, quarter, month and day, respectively.

Screen shot 504 in FIG. 5b shows a plurality of rows. Each row includes an affinity entity, the percentage of any donation that the incentee requires to be made to that affinity entity, an identifier for a community associated with the affinity entity, and a description or name of the affinity entity. Note that the sum of the second column of the row must equal one hundred percent (100%).

For the payer to make the matching donations to the Affinity Entities that are specified in screen shot 502 of FIG. 5a, the payer's financial institution can pay the designated affinity entity by way of a real time payment facilitated by any of the RTPS Technologies.

For screen shots 402-504, input and selection of data for each affinity entity (e.g., charity) can be via a typical user experience including but not limited to keyboard data entry, pull down menus, pictograph optical scanning with a cellular telephony device as read from print or electronic media rendering, etc. Horizontal 418, 518 and vertical 420, 520 panning icons can be user activated to move the rendered display, respectively, on screen shots 402-504.

Both incentor and incentee can change or disable a donation obligation to be made by a donor when a real time payment is made by a payer to a payee at any time by accessing a server that serves web pages rendering screen shots 402-504. Thus, donor donation commitments can be easily and instantly, and both enabled or disabled in real time, using the exemplary user interfaces, such as, by way of example, and not by way of limitation, by way of the use for one or more of networked servers hosted by the Donation Audit Web Service 314 seen in FIG. 3.

In some implementations, the fields provided by screen shot 502 allow an incentee, who may be a payer in a real time payment, to specify one or more affinity entities in their local community to which donations are to be made by a donor, which donor may be a payee—merchant with whom the payer conducts a transaction for goods and/or services. In such implementations, each payee-merchant is given notice of its total periodic donation obligations. Such notice, however, can optionally be given without providing the payee-merchant with any notice or knowledge as to the specific identity of those affinity entities that are to be the recipients of its donations. The donation mechanism can be set up such that the payee-merchant makes blind donations, either directly or indirectly, to affinity entities in the local community of both the payee-merchant and its payer-customer who selects those local community affinity entities. Accordingly, the donation mechanism can leave direction of payee-merchant's donations fully within the discretion of the payee-merchant's payer-customers, limited only by the restriction that the payer-customer can only select from among those affinity entities that serve the local community that is in common to both the payee-merchant and the payer-customer, while leaving the actual amount of the payee-merchant's donation fully within the discretion of the payee-merchant as shown by the incentor's input to the exemplary user interface shown in FIGS. 4a-4b.

Optionally, a further limitation on those local community affinity entities that can be selected by a payer-customer can include an algorithm that accesses a rating, and/or that derives a rating, for an affinity entity. The algorithm can use one or more ratings given by one or more affinity entity rating organizations, where the algorithm's result is used to determine whether or not the affinity entity is eligible for participation in the implementation as a registered affinity entity that is selectable by local community customers. The ratings can be retrieved by Donation Audit Web Service 314 by its access to one or more databases where such ratings are input and maintained. Example of charity rating organizations which provide one or more ratings that could be used for various disclosed implementations include Guide Star, Charity Navigator, Give Well, Evangelical Council for Financial Accountability (ECFA), the Better Business Bureau Wise Giving Alliance Standards for Charity Accountability of the Council of Better Business Bureaus, Inc., and the like that now exist or may exist in the further. Moreover, the reader will understand that current or future developed algorithms for assessing local community affinity entities can be used to determine whether or not affinity entities are eligible for participation in the disclosed implementations as registered affinity entities that are selectable by local community payer-customers and/or local payee-merchants.

In at least some implementations, the system may include one or more processors (e.g., digital signal processors, microprocessors, etc.), each being adapted to execute instructions to perform at least some of the methods, operations, and processes described herein with respect to the figures. Such instructions may be stored or held in storage media as instructions. Moreover, a non-transient computer readable medium can include such software as instructions executed by hardware to perform steps of methods described herein.

The methodologies described herein may be implemented in different ways and with different configurations depending upon the particular application. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

The herein described databases for storage media may comprise primary, secondary, and/or tertiary storage media. Primary storage media may include memory such as random access memory and/or read-only memory, for example. Secondary storage media may include a mass storage such as a magnetic or solid-state hard drive. Tertiary storage media may include removable storage media such as a magnetic or optical disk, a magnetic tape, a solid-state storage device, etc. In certain implementations, the storage media or portions thereof may be operatively receptive of, or otherwise configurable to couple to, other components of a computing platform, such as a processor.

In at least some implementations, one or more portions of the herein described storage media may store signals representative of data and/or information as expressed by a particular state of the storage media. For example, an electronic signal representative of data and/or information may be “stored” in a portion of the storage media (e.g., memory) by affecting or changing the state of such portions of the storage media to represent data and/or information as binary information (e.g., ones and zeros). As such, in a particular implementation, such a change of state of the portion of the storage media to store a signal representative of data and/or information constitutes a transformation of storage media to a different state or thing.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels.

Unless specifically stated otherwise, as apparent from the following discussion, it is appreciated that throughout this specification discussions utilizing terms such as “processing,” “computing,” “calculating,”, “identifying”, “determining”, “establishing”, “obtaining”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general-purpose computer once it is programmed to perform particular functions pursuant to instructions from program software.

Reference throughout this specification to “one example”, “an example”, “certain examples”, or “exemplary implementation” means that a particular feature, structure, or characteristic described in connection with the feature and/or example may be included in at least one feature and/or example of claimed subject matter. Thus, the appearances of the phrase “in one example”, “an example”, “in certain examples” or “in some implementations” or other like phrases in various places throughout this specification are not necessarily all referring to the same feature, example, and/or limitation. Furthermore, the particular features, structures, or characteristics may be combined in one or more examples and/or features.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all aspects falling within the scope of appended claims, and equivalents thereof.

The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes. Based on the disclosure and teachings provided herein, a person of ordinary skill in the art will appreciate other ways and/or methods for various implements. Moreover, it is understood that a functional step of described methods or processes, and combinations thereof can be implemented by computer program instructions that, when executed by a processor, create means for implementing the functional steps. The instructions may be included in non-transitory computer readable medium that can be loaded onto a general-purpose computer, a special purpose computer, or other programmable apparatus.

In the preceding detailed description, numerous specific details have been set forth to provide a thorough understanding of claimed subject matter. However, it will be understood by those skilled in the art that claimed subject matter may be practiced without these specific details. In other instances, methods and systems that would be known by one of ordinary skill have not been described in detail so as not to obscure claimed subject matter.

What is claimed is:

1. An Internet server hardware system configured to perform a method comprising a plurality of steps, wherein the steps include:
receiving information from an electronic device involved in a real time payment from a payer to a payee, wherein:
the real time payment is facilitated by one of the RTPS Technologies;
and
the information:
is derived from the real time payment from the payer to the payee as provided by the one of the RTPS Technologies; and
includes:
a date and time of the real time payment;
a currency amount of the real time payment; and
identifiers associated with the payer and payee;
accessing one or more network accessible databases to retrieve:
using the identifier associated with the payee, payee data including:
a physical address of the payee;
a payee geographic community; and
for the date and time of the real time payment:
a predetermined time threshold to navigate to the physical address of the payee;
and
at least one parameter for deriving a benefit to be given by a donor to an affinity entity designated by the payer when the payer makes the real time payment to the payee;
using the identifier associated with the payer, payer data including:
a physical address of the payer; and
an identifier of the affinity entity designated by the payer; and
using the identifier of the affinity entity designated by the payer, affinity entity data including an affinity entity geographic community;
transmitting, to an online navigation service, the respective physical addresses of the payer and payee for calculation of navigation time therebetween via one or more travel times each taking into consideration real time traffic conditions at the date and time of the real time payment for each of one or more routes via one or more transportation modes between the respective physical addresses of the payer and payee;
receiving, from the online navigation service, for the real time traffic conditions at the date and time of the transaction, one or more said travel time for at least one said route for at least one said transportation mode;
and if:
for the real time traffic conditions at the date and time of the transaction, at least one said travel time for at least one said route for at least one said transportation mode does not exceed the predetermined time threshold;
and
the affinity entity geographic community matches the payee geographic community;
then:
determining, using the at least one parameter and the currency amount of the real time payment, the benefit to be given by the donor to the affinity entity designated by the payer;
and
transmitting, to a logical address of a web enabled mobile computing device corresponding to the payer, a message containing an identifier of the benefit to be given by the donor to the affinity entity designated by the payer.

2. The method as defined in claim 1, wherein:
the benefit to be given by the donor to the affinity entity designated by the payer is a percentage of the currency amount of the real time payment;
and
the method further comprises:
at a predetermined time period after the date of the real time payment:
receiving a plurality of donation receipts each including:
the respective identifiers for the donor and the affinity entity; and
a currency amount received for the affinity entity from the donor;
deriving the sum of the currency amounts of the donation receipts for the affinity entity from the donor;
determining a difference between:
the derived sum of the currency amounts of the donation receipts for the affinity entity from the donor; and
the sum of the currency amount in each said message that were transmitted to the logical address of the web enabled mobile computing device corresponding to the payer;
and
transmitting the determined difference to the logical address of the web enabled mobile computing device corresponding to the payer.

3. The method as defined in claim 2, further comprising transmitting the message and the determined difference to a logical address associated with a selection from the group consisting of:
a logical address for the payee;
a logical address for the payer;
a logical address for the affinity entity; and
a combination thereof

4. The method as defined in claim 1, wherein the information derived from the real time payment from the payer to the payee is provided by operation of the one of the RTPS Technologies so as to be communicated incident to the real time payment from the payer to the payee after the real time payment from the payer to the payee.

5. The method as defined in claim 1, wherein the payee has a geographic community and the affinity entity has a geographic community that are selected from the group consisting of a province, a state, a county in a state, a prefecture, a city in a state, a city-state, a borough in a city, and a postal code for the delivery of posted mail.

6. The method as defined in claim 1, wherein the transportation mode is selected from the group consisting of walking, automobile, bicycle, mass transit, and a combination thereof

7. The method as defined in claim 1, wherein the steps further comprise retrieving, using at least one of the respective payer, payee, and affinity entity identifiers, a logical address selected from the group consisting of:
the logical address of the payer;
the logical address of the payee;
the logical address of the affinity entity;
the donor; and
a combination thereof

8. The method as defined in claim 2, wherein:
each said real time payment in a real time payment processing system having a plurality of said payees conducting transactions on respective accounts issued to respective said payers by respective issuers; and
each said real time payment for each said transaction on each said account is cleared and settled by operation of the one said RTPS Technologies.

9. The method as defined in claim 1, further comprising transmitting a message to a logical address corresponding to the payee; wherein:
the message transmitted to the logical address of the payer an identification of the affinity entity;
and
the message sent to the logical address of the payee does not identify the affinity entity.

10. The method as defined in claim 9, wherein the logical address further comprises a plurality of said logical addresses each respectively corresponding to a physical resident of the geographic community of the affinity entity, whereby the plurality of the transmitted messages facilitate fundraising by social motivation of the payers who are physical residents of the geographic community by the making of said real time payments to the payees.

11. The method as defined in claim 9, wherein:
the benefit to be given by the donor to the affinity entity designated by the payer is a percentage of a currency amount of the real time payment;
the information derived from operation of the one said RTPS Technologies includes the currency amount of the real time payment;
and
at a predetermined time period after the date of the real time payment, the method further comprises:
receiving a plurality of donation receipts each including:
the respective identifiers for the donor and the affinity entity; and
a currency amount received for the affinity entity from the donor;
deriving the sum of the currency amounts of the donation receipts for the affinity entity from the donor;
determining a difference between:
the derived sum of the currency amounts of the donation receipts for the affinity entity from the donor;
and
the sum of the currency amount in each said message that were transmitted to the logical address of the web enabled mobile computing device corresponding to the payer;
and
transmitting the determined difference to the logical address of the web enabled mobile computing device corresponding to the payer.

12. The method as defined in claim 1, wherein the donor is the payee.

13. An Internet server hardware system configured to perform a method comprising a plurality of steps, wherein the steps include:
receiving information for a real time payment from a payer to a payee through an operation of one of the RTPS Technologies, wherein:
the real time payment occurs in a real time payment processing system having a plurality of said payees receiving said real time payment from said payers on respective payer accounts issued to respective said payers by respective payer financial institutions;
the real time payment each said payer account is cleared and settled through the operation of one of the RTPS Technologies;
and
the information:
is derived through the operation of one of the RTPS Technologies; and
includes:
a date and time of the real time payment;
a currency amount of the real time payment; and
identifiers associated with the payer, the payee, and a donor;
accessing one or more network accessible databases to retrieve:
using the identifier associated with the payee, payee data including:
a physical address of the payee;
a payee geographic community; and
for the date and time of the real time payment:
a predetermined time threshold to navigate to the physical address of the payee; and
at least one parameter for deriving a benefit to be given by the donor to an affinity entity designated by the payer, wherein the benefit is a percentage of the currency amount of the real time payment;
using the identifier associated with the payer, payer data including:
a physical address of the payer; and
an identifier of the affinity entity designated by the payer;
using the identifier of the affinity entity designated by the payer, affinity entity data including:
an affinity entity geographic community;
a physical address of the payer; and
an identifier of the affinity entity designated by the payer; and
using the identifier of the affinity entity designated by the payer, affinity entity data including:
an affinity entity geographic community;
transmitting, to an online navigation service, the respective physical addresses of the payer and payee for calculation of navigation time therebetween via one or more travel times each taking into consideration real time traffic conditions at the date and time of the transaction for each of one or more routes via one or more transportation modes between the respective physical addresses of the payer and payee;
receiving, from the online navigation service, for the real time traffic conditions at the date and time of the transaction, one or more said travel time for at least one said route for at least one said transportation mode;
and if
for the real time traffic conditions at the date and time of the transaction, at least one said travel time for at least one said route for at least one said transportation mode does not exceed the predetermined time threshold;
and
the affinity entity geographic community matches the payee geographic community;
then:
determining, using the at least one parameter and the currency amount of the real time payment, the benefit to be given by the donor to the affinity entity designated by the payer;
and
transmitting, to a logical address of a web enabled mobile computing device corresponding to the payer, a message containing an identifier of the benefit to be given by the donor to the affinity entity designated by the payer.

14. The method as defined in claim 13, wherein the transportation mode is selected from the group consisting of walking, automobile, bicycle, mass transit, and a combination thereof,

15. The method as defined in claim 13, wherein the donor is the payee.

16. A non-transient computer readable medium comprising the software as defined in claim 13.

17. An Internet server hardware system configured to perform a method comprising a plurality of steps, wherein the steps include:
receiving information from an electronic device involved in a real time payment from a payer to a payer on a payer account issued to the payer by a payer financial institution, wherein:
the real time payment occurs in a real time payment processing system by way of an operation of one of the RTPS Technologies, wherein the real time payment processing system includes a plurality of said payees receiving a plurality of said real time payment from a plurality of said payers on respective said payer accounts issued to respective said payers by respective said payer financial institutions;
the real time payment on each said payer account is cleared and settled by the operation of the one of the RTPS Technologies;
the information:
is derived from the real time payment by the operation of the one of the RTPS Technologies;
and
includes:
a date and time of the real time payment;
a currency amount of the real time payment; and
identifiers associated with the payer, the payee, and a donor;
accessing one or more network accessible databases to retrieve:
using the identifier associated with the payee, payee data including:
a physical address of the payee;
a payee geographic community; and
for the date and time of the real time payment:
a predetermined time threshold to navigate to the physical address of the payee; and
at least one parameter for deriving a benefit to be given by the donor to an affinity entity designated by the payer;
using the identifier associated with the payer, payer data including:
a physical address of the payer; and
an identifier of the affinity entity designated by the payer; and
using the identifier of the affinity entity designated by the payer, affinity entity data including an affinity entity geographic community;
transmitting, to an online navigation service, the respective physical addresses of the payee and the payer for calculation of navigation time therebetween via one or more travel times each taking into consideration real time traffic conditions at the date and time of the transaction for each of one or more routes via one or more transportation modes between the respective physical addresses of the payee and the payer;
receiving, from the online navigation service, for the real time traffic conditions at the date and time of the transaction, one or more said travel time for at least one said route for at least one said transportation mode;
and if:
for the real time traffic conditions at the date and time of the transaction, at least one said travel time for at least one said route for at least one said transportation mode does not exceed the merchant travel time threshold;
and
the affinity entity geographic community matches the payee geographic community;
then:
determining, using the at least one parameter and the currency amount of the transaction, the benefit to be given by the donor to the affinity entity designated by the payer;
and
transmitting, to a logical address of a web enabled mobile computing device corresponding to the payer, a message containing an identifier of the benefit to be given by the donor to the affinity entity designated by the payer, wherein:
the benefit to be given by the donor to the affinity entity designated by the payer is a percentage of the currency amount of the real time payment;
and
the method further comprises:
at a predetermined time period after the date of the real time payment:
receiving a plurality of donation receipts each including:
the respective identifiers for the donor and the affinity entity;
and
a currency amount received for the affinity entity from the donor;
deriving the sum of the currency amounts of the donation receipts for the affinity entity from the donor;
determining a difference between:
the derived sum of the currency amounts of the donation receipts for the affinity entity from the donor; and
the sum of the currency amount in each said message that were transmitted to the logical address of a web enabled mobile computing device corresponding to the payer;
and
transmitting the determined difference to the logical address of a web enabled mobile computing device corresponding to the payer.

18. The method as defined in claim 15, wherein:
the payee geographic community and the affinity entity geographic community are selected from the group consisting of a province, a state, a county in a state, a prefecture, a city in a state, a city-state, a borough in a city, and a postal code for the delivery of posted mail; and
the transportation mode is selected from the group consisting of walking, automobile, bicycle, mass transit, and a combination thereof; and

19. The method as defined in claim 17, wherein the donor is the payee.

20. A non-transient computer readable medium comprising software executed by the Internet server hardware system to perform the steps of the method as defined in claim 17.
